(19) United States
(12) Patent Application Publication
(10) Pub. No.: US 2020/0018679 A1
(43) Pub. Date: Jan. 16, 2020

(54) PARTICULATE MATTER DETECTION SENSOR AND PARTICULATE MATTER DETECTION APPARATUS

(71) Applicant: DENSO CORPORATION, Kariya-city, Aichi-pref. (JP)

(72) Inventors: Kazuhiko KOIKE, Nisshin-city, Aichi-pref. (JP); Masahiro YAMAMOTO, Kariya-city, Aichi-pref. (JP); Michiyasu MORITSUGU, Nisshin-city, Aichi-pref. (JP); Kensuke TAKIZAWA, Nisshin-city, Aichi-pref. (JP)

(21) Appl. No.: 16/340,231

(22) PCT Filed: Oct. 5, 2017
(86) PCT No.: PCT/JP2017/036359

§ 371 Date: Apr. 8, 2019

(30) Foreign Application Priority Data
Oct. 12, 2016 (JP) 2016-201070
Apr. 4, 2017 (JP) 2017-074706
Apr. 14, 2017 (JP) 2017-080740
Sep. 19, 2017 (JP) 2017-179388

(51) Int. Cl. G01N 15/06; G01N 1/22; F01N 13/00; G01N 27/04

(52) U.S. Cl. CPC G01N 15/0656; G01N 1/2252; F01N 2560/20; G01N 27/043; F01N 2560/05; F01N 13/008

(57) ABSTRACT

A detection conductive section and a monitor conductive section made of a conductive material having a higher electrical resistivity than that of PM are included. A deposition surface on which the PM is deposited is provided to the detection conductive section. A pair of detection electrodes are provided to the deposition surface. A pair of monitor electrodes are provided to the monitor conductive section. The configuration is made such that no PM is deposited on the monitor conductive section between the pair of monitor electrodes.

### CROSS-REFERENCE TO RELATED APPLICATIONS

The present application is based on Japanese Patent Application No. 2016-201070 filed on Oct. 12, 2016, Japanese Patent Application No. 2017-74706 filed on Apr. 4, 2017, Japanese Patent Application No. 2017-80740 filed on Apr. 14, 2017, and Japanese Patent Application No. 2017-179388 filed on Sep. 19, 2017, the contents of which are incorporated herein by reference.

### TECHNICAL FIELD

The present disclosure relates to a particulate matter detection sensor and a particulate matter detection apparatus for detecting an amount of particulate matter contained in exhaust gas.

### BACKGROUND ART

Known particulate matter detection sensors (also termed PM sensors hereinafter) for detecting an amount of particulate matter (also termed PM hereinafter) contained in exhaust gas include a PM sensor including an insulating substrate provided with a deposition surface on which PM is deposited and a pair of detection electrodes provided on the deposition surface. PM is composed of soot and has electrical conductivity. Thus, when PM is deposited on the deposition surface, the pair of detection electrodes are electrically connected by the PM, and an electric current flows. The PM sensor is configured to detect an amount of PM deposited on the deposition surface, by measuring a value of the electric current.

However, the PM sensor has a problem in which PM is undetectable when the deposition amount of PM is small. Specifically, in the PM sensor, an electric current starts flowing after a certain amount of PM is deposited on the deposition surface and a current path has been formed by the PM between the pair of detection electrodes. Accordingly, when the deposition amount of PM is small and no current path has been formed, an electric current does not flow between the pair of detection electrodes, and thus no PM can be detected (see FIG. 58).

In recent years, in order to solve the problem, a PM sensor has been developed which uses a conductive section made of a conductive material having a higher electrical resistivity than PM (see Patent Literature 1 below). In the PM sensor, a deposition surface on which PM is deposited is provided on a surface of the conductive section, and a pair of detection electrodes are provided on the deposition surface. Since the conductive section is made of the conductive material, even when no PM is deposited on the deposition surface, an electric current flows through the conductive section (see FIG. 7). Furthermore, when a small amount of PM is deposited on the deposition surface (see FIG. 8), in regions of the deposition surface in which no PM is deposited, an electric current flows through the conductive section, and in a region of the deposition surface in which the PM is deposited, an electric current mainly flows through the PM whose electrical resistivity is low. Accordingly, even when the deposition amount of PM is small and no current path has been formed by the PM between the pair of detection electrodes, an electric current can flow between the detection electrodes. Furthermore, according to the deposition amount of PM, electrical resistance between the detection electrodes is changed, and thus a value of the electric current is changed. Therefore, even when a small amount of PM is deposited, the deposition amount of PM can be detected.

### CITATION LIST

### Patent Literature

[PTL 1] JP 2016-138449 A

### SUMMARY OF THE INVENTION

The above PM sensor has a problem in which a detection value of the deposition amount of PM is highly variable according to the temperature. Specifically, the PM sensor has a structure in which an electric current flows through the conductive section, and electrical resistance of the conductive section is greatly changed according to the temperature. Accordingly, even if the deposition amount of PM is constant, when the temperature is changed, the electrical resistance of the conductive section is changed, and thus the electrical resistance between the pair of detection electrodes is greatly changed. This makes it difficult to accurately detect the deposition amount of PM.

The present disclosure is to provide a particulate matter detection sensor capable of detecting a deposition amount of particulate matter even when the deposition amount of particulate matter is small, and easily preventing a change in detection value according to a temperature, and a particulate matter detection apparatus including the particulate matter detection sensor.

A first aspect of the present disclosure is a particulate matter detection sensor for detecting an amount of particulate matter contained in exhaust gas, the particulate matter detection sensor including:

a particulate matter detection section; and a resistance monitor section, wherein the particulate matter detection section includes a detection conductive section and a pair of detection electrodes, the detection conductive section is made of a conductive material having a higher electrical resistivity than that of the particulate matter and has a surface on which a deposition surface is provided, the particulate matter being deposited on the deposition surface, the pair of detection electrodes are provided to the detection conductive section and face each other across the deposition surface, the particulate matter detection section is configured such that an electrical resistance between the pair of detection electrodes is changed according to the amount of the particulate matter deposited on the deposition surface, the resistance monitor section includes a monitor conductive section and a pair of monitor electrodes, the monitor conductive section is made of the conductive material and is arranged at a position adjacent to the detection conductive section, the pair of monitor electrodes are provided to the monitor conductive section, and the resistance monitor section is configured such that no particulate matter is deposited on the monitor conductive section between the pair of monitor electrodes.

A second aspect of the present disclosure is a particulate matter detection apparatus including: the particulate matter detection sensor; and a control section connected to the particulate matter detection sensor, wherein the control section includes a main measurement section, a compensation measurement section, and a deposition amount calculation section, the main measurement section measures a particulate matter detection resistance which is an electrical resistance between the pair of detection electrodes, the compensation measurement section measures a compensation resistance which is an electrical resistance between the pair of monitor electrodes, and the deposition amount calculation section compensates for a change, according to a temperature, in electrical resistance of the detection conductive section between the pair of detection electrodes by using a measured value of the compensation resistance, and calculates an amount of the particulate matter deposited on the deposition surface.

A third aspect of the present disclosure is a particulate matter detection apparatus including: a particulate matter detection sensor for detecting an amount of particulate matter contained in exhaust gas; and a control section connected to the particulate matter detection sensor, wherein

the particulate matter detection sensor includes a detection conductive section and a pair of detection electrodes, the detection conductive section is made of a conductive material having a higher electrical resistivity than that of the particulate matter and has a surface on which a deposition surface is provided, the particulate matter being deposited on the deposition surface, the pair of detection electrodes are provided to the detection conductive section and face each other across the deposition surface, the particulate matter detection sensor is configured such that an electrical resistance between the pair of detection electrodes is changed according to an amount of particulate matter deposited on the deposition surface, and

the control section is configured to increase a temperature of the detection conductive section and detect the particulate matter while the temperature of the detection conductive section is controlled so that a detection conductive section resistance is within a predetermined range in a state in which no particulate matter is deposited, the detection conductive section resistance being an electrical resistance of the detection conductive section between the pair of detection electrodes.

### Advantageous Effects of the Invention

The particulate matter detection sensor according to the first aspect includes the detection conductive section provided with the deposition surface and the pair of detection electrodes facing each other across the deposition surface. The detection conductive section is made of the conductive material having a higher electrical resistivity than that of particulate matter.

Thus, even when no particulate matter is deposited on the deposition surface, an electric current can flow between the pair of detection electrodes. Furthermore, when a small amount of particulate matter is deposited on the deposition surface (see FIG. 8), in regions of the deposition surface in which no particulate matter is deposited, an electric current flows through the detection conductive section, and in a region of the deposition surface in which the particulate matter is deposited, an electric current mainly flows through the particulate matter whose electrical resistivity is low. Accordingly, even when the deposition amount of particulate matter is small and no current path has been formed by the particulate matter between the detection electrodes, an electric current can flow between the detection electrodes. Furthermore, according to the deposition amount of particulate matter, the electrical resistance between the detection electrodes is changed, and thus a value of the electric current is changed. Therefore, even when a small amount of particulate matter is deposited, the deposition amount of particulate matter can be detected.

Furthermore, the particulate matter detection sensor includes the resistance monitor section. The resistance monitor section includes the monitor conductive section and the pair of monitor electrodes provided to the monitor conductive section.

Accordingly, it is possible to compensate for the change in the electrical resistance of the detection conductive section according to the temperature. Thus, the deposition amount of particulate matter can be accurately measured. Specifically, since the detection conductive section is arranged at the position adjacent to the monitor conductive section, the temperature of the detection conductive section is almost equal to the temperature of the monitor conductive section. Furthermore, since the resistance monitor section is configured such that no particulate matter is deposited on the monitor conductive section, the electrical resistance of the monitor conductive section between the monitor electrodes is hardly influenced by the particulate matter. Thus, by measuring the electrical resistance of the monitor conductive section between the monitor electrodes, it is possible to calculate the electrical resistance of the detection conductive section at the same temperature as that of the monitor conductive section in a state in which no particulate matter is deposited.

As described above, the particulate matter detection sensor has a structure in which an electric current between the detection electrodes flows through the detection conductive section, and the electrical resistance of the detection conductive section is greatly changed according to the temperature. In the present aspect, since the electrical resistance of the detection conductive section can be calculated by measuring the electrical resistance between the pair of monitor electrodes, it is possible to compensate for the change in the electrical resistance of the detection conductive section according to the temperature. Thus, the deposition amount of particulate matter can be accurately obtained.

The particulate matter detection apparatus according to the second aspect includes the particulate matter detection sensor and the control section connected to the particulate matter detection sensor. The control section includes the main measurement section, the compensation measurement section, and the deposition amount calculation section.

Thus, the deposition amount of particulate matter can be accurately and reliably calculated.

The control section according to the third aspect is configured to increase the temperature of the detection conductive section and detect the particulate matter while the temperature of the detection conductive section is controlled so that the detection conductive section resistance is within the predetermined range.

Accordingly, the particulate matter can be detected after the detection conductive section resistance has reached an optimum value. Thus, the amount of particulate matter can be accurately detected.

As has been described, the present aspect can provide a particulate matter detection sensor capable of detecting the deposition amount of particulate matter even when the deposition amount of particulate matter is small, and easily preventing a change in detection value according to a temperature, and a particulate matter detection apparatus including the particulate matter detection sensor.

### BRIEF DESCRIPTION OF THE DRAWINGS

The above object and other objects, features, and advantages of the present disclosure will be clarified by the following detailed description with reference to the accompanying drawings.

FIG. 1 is a perspective view of a particulate matter detection sensor according to a first embodiment.

FIG. 2 is a plan view of the particulate matter detection sensor viewed in the direction of arrow II of FIG. 3, according to the first embodiment.

FIG. 3 is a cross-sectional view cut along III-III of FIG. 2.

FIG. 4 is a plan view of the particulate matter detection sensor from which detection electrodes are removed according to the first embodiment.

FIG. 5 is a conceptual diagram of a particulate matter detection apparatus according to the first embodiment.

FIG. 6 is a conceptual diagram of the particulate matter detection sensor and a detection circuit according to the first embodiment.

FIG. 7 is a partial cross-sectional view of the particulate matter detection sensor in a state in which no particulate matter is deposited, according to the first embodiment.

FIG. 8 is a partial cross-sectional view of the particulate matter detection sensor in a state in which a small amount of particulate matter is deposited, according to the first embodiment.

FIG. 9 is a graph showing a relationship between a deposition amount of particulate matter and an electric current flowing between the detection electrodes, according to the first embodiment.

FIG. 10 is a graph showing a relationship between temperature and electric currents flowing between electrodes when the deposition amount of particulate matter is constant, according to the first embodiment.

FIG. 11 is a graph showing a relationship between temperature and a corrected value of the electric current between the detection electrodes when the deposition amount of particulate matter is constant, according to the first embodiment.

FIG. 12 is a flow chart for a control section according to the first embodiment.

FIG. 13 is a conceptual diagram of a particulate matter detection apparatus according to a second embodiment.

FIG. 14 is a graph showing a relationship between compensation resistance and temperature, according to the second embodiment.

FIG. 15 is a flow chart for a temperature calculation section, according to the second embodiment.

FIG. 16 is a conceptual diagram of a particulate matter detection apparatus according to a third embodiment.

FIG. 17 is a graph showing a relationship between resistivity of the particulate matter and temperature, according to the third embodiment.

FIG. 18 is a graph showing a relationship between a corrected PM current and temperature, according to the third embodiment.

FIG. 19 is a flow chart for the control section, according to the third embodiment.

FIG. 20 is a graph showing a relationship between a ratio of an electric current flowing between monitor electrodes and an electric current flowing between the detection electrodes and an interval between the monitor electrode and the detection electrode, according to a first experimental example.

FIG. 21 is a perspective view of a particulate matter detection sensor according to a fourth embodiment.

FIG. 22 is a cross-sectional view of a particulate matter detection sensor, according to a fifth embodiment.

FIG. 23 is a cross-sectional view of a particulate matter detection sensor viewed in the direction of arrow XXIII of FIG. 24, according to a sixth embodiment.

FIG. 24 is a cross-sectional view cut along XXIV-XXIV of FIG. 23.

FIG. 25 is a perspective view of a particulate matter detection sensor according to a seventh embodiment.

FIG. 26 is a cross-sectional view cut along XXVI-XXVI of FIG. 25.

FIG. 27 is a cross-sectional view of a particulate matter detection sensor according to an eighth Embodiment.

FIG. 28 is a cross-sectional view of a particulate matter detection sensor according to a ninth embodiment.

FIG. 29 is a graph showing a relationship between surface electrical resistivity ρ and temperature of Sr₁₋ₓLaxTiO₃, according to a tenth embodiment.

FIG. 30 is a graph showing a relationship between an amount of emitted PM and sensor output for a plurality of PM sensors in which surface electrical resistivities p of a conductive section are different, according to the tenth embodiment.

FIG. 31 is a diagram illustrating a method of measuring the surface electrical resistivity ρ, according to the tenth embodiment.

FIG. 32 is a graph showing a relationship between thickness of a sample and electrical resistance, according to the tenth embodiment.

FIG. 33 is a graph showing a relationship between resistivity and temperature of SrTiO₃ obtained by changing a method of measuring the resistivity, according to the tenth embodiment.

FIG. 34 is a diagram illustrating a method of measuring bulk electrical resistivity, according to the tenth embodiment.

FIG. 35 is a plan view of a particulate matter detection sensor viewed in the direction of arrow XXXV of FIG. 36, according to an eleventh embodiment.

FIG. 36 is a cross-sectional view cut along XXXVI-XXXVI of FIG. 35.

FIG. 37 is a graph showing a relationship between a deposition amount of PM and an electric current flowing between the detection electrodes before and after heating, according to the eleventh embodiment.

FIG. 38 is a conceptual diagram of a circuit connected to the particulate matter detection sensor, according to the eleventh embodiment.

FIG. 39 is a graph showing a relationship between electrical resistivity of conductive materials constituting the detection conductive section and the monitor conductive section and temperature, according to the eleventh embodiment.

FIG. 40 is a flow chart for the control section according to the eleventh embodiment.

FIG. 41 is a flow chart for the control section according to a twelfth embodiment.

FIG. 42 is a cross-sectional view of a particulate matter detection sensor according to a thirteenth embodiment.

FIG. 43 is a plan view of a particulate matter detection sensor viewed in the direction of arrow XLIII of FIG. 44, according to a fourteenth embodiment.

FIG. 44 is a cross-sectional view cut along XLIV-XLIV of FIG. 43.

FIG. 45 is a conceptual diagram of a circuit connected to a heater, according to the fourteenth embodiment.

FIG. 46 is a flow chart for the control section according to the fourteenth embodiment.

FIG. 47 is a conceptual diagram of a circuit connected to the particulate matter detection sensor, according to a fifteenth embodiment.

FIG. 48 is a flow chart for the control section according to the fifteenth embodiment.

FIG. 49 is a flow chart for the control section according to a sixteenth embodiment.

FIG. 50 is a cross-sectional view of a particulate matter detection sensor according to a seventeenth embodiment.

FIG. 51 shows output characteristics of the PM sensor in which the monitor electrodes and the monitor conductive section are covered with an insulating film having no gas permeability, according to the seventeenth embodiment.

FIG. 52 shows output characteristics of the particulate matter detection sensor in which the monitor electrodes and the monitor conductive section are covered with an insulating film having gas permeability, according to the seventeenth embodiment.

FIG. 53 is a conceptual diagram showing changes in temperature of exhaust gas, the detection conductive section, and the monitor conductive section, when the monitor conductive section and the like are covered with the insulating film having no gas permeability, according to the seventeenth embodiment.

FIG. 54 is a conceptual diagram showing changes in temperature of exhaust gas, the detection conductive section, and the monitor conductive section, when the monitor conductive section and the like are covered with the insulating film having gas permeability, according to the seventeenth embodiment.

FIG. 55 is a cross-sectional view of the particulate matter detection sensor in which the monitor conductive section and the detection conductive section are laminated, according to the seventeenth embodiment.

FIG. 56 is a cross-sectional view of the particulate matter detection sensor in which the monitor conductive section is integrated with the detection conductive section, according to the seventeenth embodiment.

FIG. 57 is a partial cross-sectional view of the particulate matter detection sensor in a state in which no particulate matter is deposited, according to a first comparative embodiment.

FIG. 58 is a partial cross-sectional view of the particulate matter detection sensor in a state in which a small amount of particulate matter is deposited, according to the first comparative embodiment.

FIG. 59 is a partial cross-sectional view of the particulate matter detection sensor in a state in which a current path is formed with the deposited particulate matter, according to the first comparative embodiment.

FIG. 60 is a graph showing a relationship between a deposition amount of particulate matter and an electric current flowing between the detection electrodes, according to the first comparative embodiment.

FIG. 61 is a graph showing a relationship between a deposition amount of particulate matter and an electric current flowing between the detection electrodes, according to a second comparative embodiment.

FIG. 62 is a graph showing a relationship between a deposition amount of particulate matter and an electric current flowing between the detection electrodes, according to a third comparative embodiment.

### DESCRIPTION OF THE EMBODIMENTS

The particulate matter detection sensor is applicable to an in-vehicle particulate matter detection sensor for detecting an amount of particulate matter contained in exhaust gas in an engine of a vehicle.

### First Embodiment

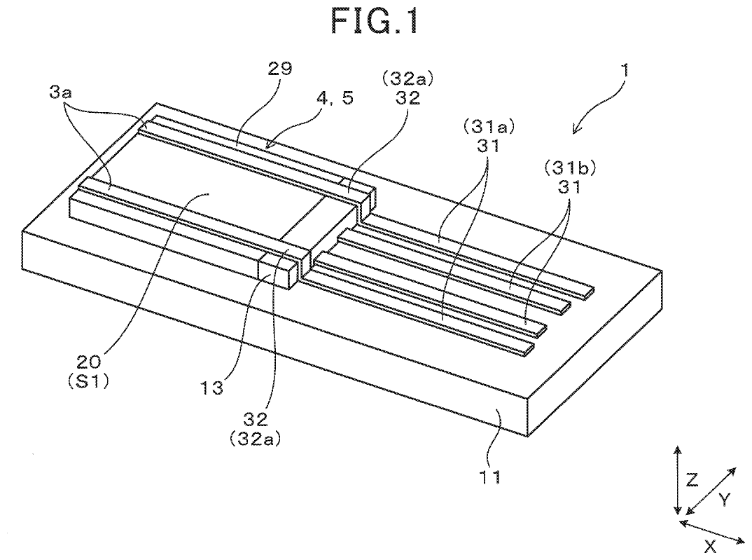

An embodiment of the particulate matter detection sensor and the particulate matter detection apparatus will be described with reference to FIGS. 1 to 12. The particulate matter detection sensor (i.e., PM sensor 1) of the present embodiment is used for detecting an amount of particulate matter 8 contained in exhaust gas. As illustrated in FIGS. 1 to 3, the PM sensor 1 includes a particulate matter detection section 4 and a resistance monitor section 5.

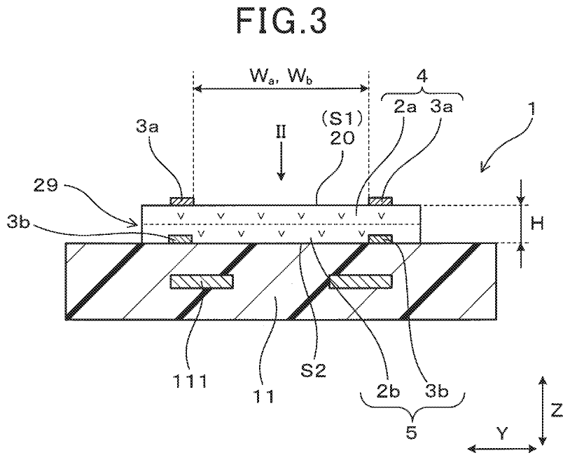

As illustrated in FIG. 3, the particulate matter detection section 4 includes a detection conductive section 2a and a pair of detection electrodes 3a. The detection conductive section 2a is made of a conductive material having a higher electrical resistivity than the PM 8.

The electrical resistivity of the PM 8 can be measured by a powder resistance measurement method below. Specifically, powder (PM) is placed in a predetermined cylindrical container (cross-sectional area: A) whose bottom and upper surfaces are electrode plates, and while pressure is applied from above to the electrode plate of the upper surface to compress the powder (PM) in a longitudinal axis direction, a distance L between the electrodes and a resistance R between the electrodes are measured. According to this measurement method, a resistivity ρ of the powder (PM) is calculated by R×(A/L). In the present embodiment, a cylindrical container having a cross section of 6 mmϕ (cross-sectional area: 2.83×10⁻⁵ m²) is used to measure the resistance value R while a pressure of 60 kgf is applied to the container. According to the measurement, the resistivity of PM is specifically in a range of 10⁻³ to 10² Ω·cm. The generated electrical resistivity of PM varies depending on an engine operating condition. For example, when PM is emitted under an operating condition with high load and high rotation speed, contains a small amount of unburned hydrocarbon component, and is mostly composed of soot, the PM has an electrical resistivity of approximately 10⁻³ Ω·cm. When PM is emitted from the engine operating under a condition with low rotation speed and low load, contains a large amount of unburned hydrocarbon component, and has a highest resistivity, the PM has an electrical resistivity of approximately 10² Ω·cm. Thus, the detection conductive section 2a of the present embodiment preferably has an electrical resistivity of at least 10² Ω·cm or more.

As illustrated in FIG. 3, a deposition surface 20 on which PM is deposited is provided on a surface of the detection conductive section 2a. The pair of detection electrodes 3a are provided on the detection conductive section 2a and face each other across the deposition surface 20. The particulate matter detection section 4 is configured such that an electrical resistance between the pair of detection electrodes 3a is changed according to the amount of PM 8 deposited on the deposition surface 20.

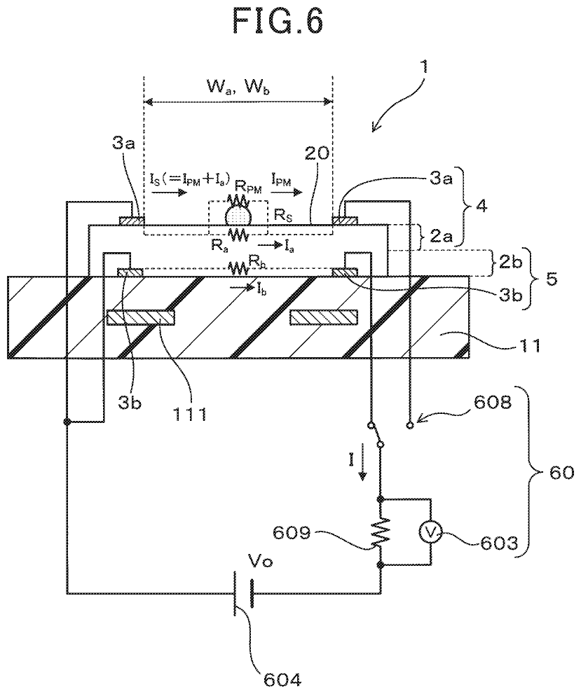

The resistance monitor section 5 is provided for compensating for a change, which is according to a temperature, in electrical resistance Rₐ (see FIG. 6; also termed detection conductive section resistance Rₐ hereinafter) of the detection conductive section 2a between the pair of detection electrodes 3a. The resistance monitor section 5 includes a monitor conductive section 2b and a pair of monitor electrodes 3b. The monitor conductive section 2b is made of the conductive material and is arranged at a position adjacent to the detection conductive section 2a. The pair of monitor electrodes 3b are provided in the monitor conductive section 2b. The resistance monitor section 5 is configured such that no PM 8 is deposited on the monitor conductive section 2b between the pair of monitor electrodes 3b.

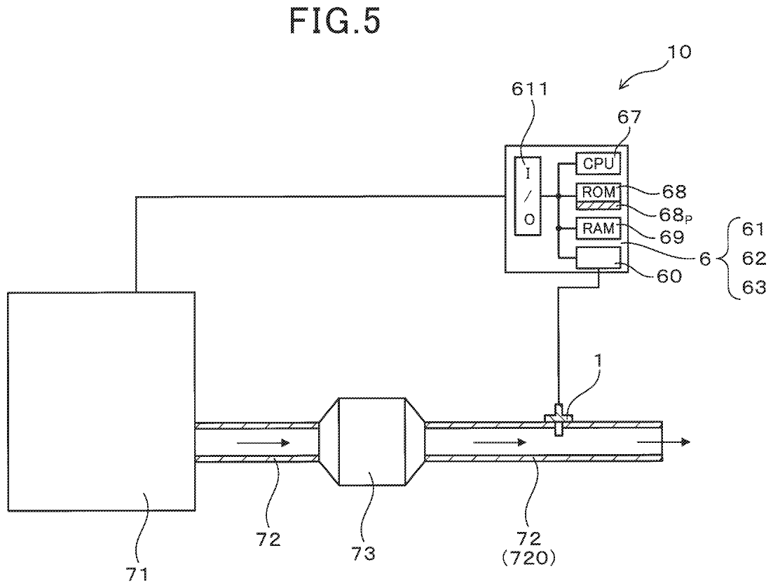

As illustrated in FIG. 5, the PM sensor 1 of the present embodiment is an in-vehicle PM sensor for detecting the amount of PM 8 contained in exhaust gas in an engine 71 of the vehicle. An exhaust pipe 72 is connected to the engine 71. The exhaust pipe 72 is provided with a purification device 73 for purifying the exhaust gas. The PM sensor 1 is attached to a portion 720 of the exhaust pipe 72 located further downstream of the exhaust gas than the purification device 73. In the present embodiment, the amount of PM 8 contained in the exhaust gas that has passed through the purification device 73 is measured by using the PM sensor 1, and fault diagnosis of the purification device 73 is performed by using a measured value of the amount of PM 8.

The PM sensor 1 is connected to a control section 6. The control section 6 and the PM sensor 1 constitute a particulate matter detection apparatus 10 (also termed PM detection apparatus 10 hereinafter). The control section 6 is constituted by an ECU (Engine Control Unit). The control section 6 includes a CPU 67, a ROM 68, a RAM 69, an I/O 611, and a detection circuit 60. The ROM 68 stores a program 68p. When the CPU 67 reads and executes the program 68p, a main measurement section 61, a compensation measurement section 62, and a deposition amount calculation section 63, and the like (described later) are thereby implemented.

As illustrated in FIG. 6, the detection circuit 60 includes a switch 608, a shunt resistor 609, a voltage measurement section 603, and a DC power supply 604. The detection circuit 60 is configured to control the switch 608 to apply a voltage Vₒ of the DC power supply 604 to either the pair of detection electrodes 3a or the pair of monitor electrodes 3b. An electric current I that has flowed between the detection electrodes 3a or between the monitor electrodes 3b passes through the shunt resistor 609. A voltage drop caused by the shunt resistor 609 is measured by the voltage measurement section 603. Thus, the detection circuit 60 is configured to measure the electric current I and calculate an electrical resistance (=Vₒ/I) between the electrodes.

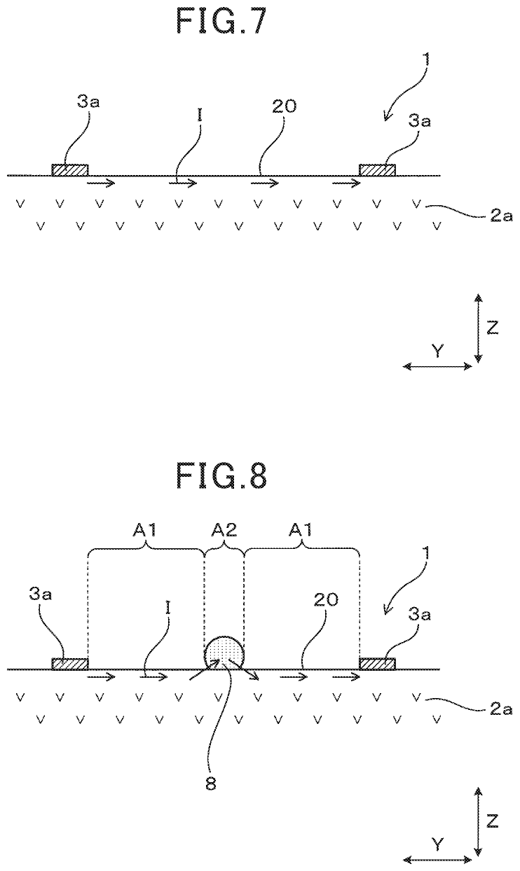

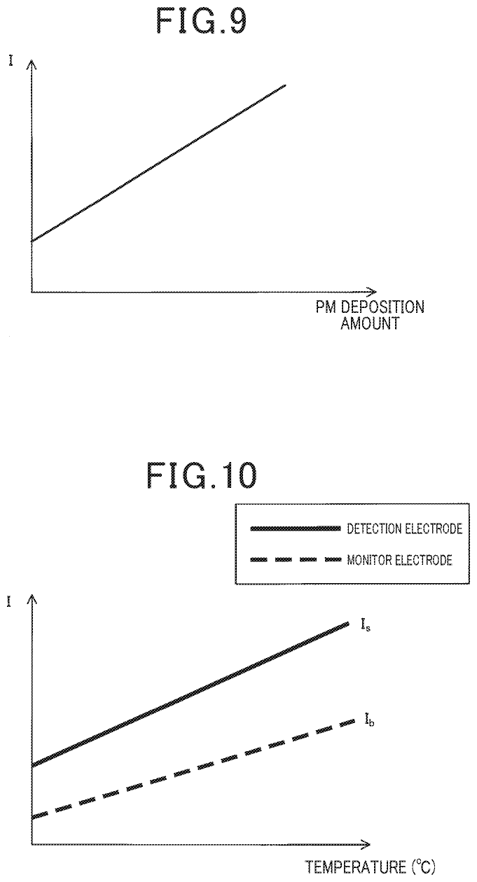

As described above, the detection conductive section 2a is made of the conductive material. Accordingly, as illustrated in FIG. 7, even in a state in which no PM 8 is deposited on the deposition surface 20, the electric current I can flow thorough the detection conductive section 2a. Furthermore, as illustrated in FIG. 8, when a small amount of PM 8 is deposited, in regions A1 of the deposition surface 20 in which no PM 8 is deposited, the electric current I flows through the detection conductive section 2a, and in a region A2 of the deposition surface 20 in which the PM 8 is deposited, the electric current I mainly flows through the PM 8 whose electrical resistivity is low. Accordingly, as shown in FIG. 9, even when the deposition amount of PM 8 is small, the electric current I is changed, and thus the deposition amount of PM 8 can be detected.

The structure of the PM sensor 1 will be described in more detail below. As illustrated in FIG. 3, the detection conductive section 2a is integrated with the monitor conductive section 2b to constitute a single conductive plate section 29. The conductive plate section 29 is supported by a substrate section 11. The monitor conductive section 2b is a portion of the conductive plate section 29 on the side closer to the substrate section 11 in a plate thickness direction (also termed a Z direction hereinafter) of the conductive plate section 29. The detection conductive section 2a is a portion of the conductive plate section 29 on the side opposite to the monitor conductive section 2b. Furthermore, the monitor electrodes 3b are provided on a principal surface S2 of the conductive plate section 29 in contact with the substrate section 11. The deposition surface 20 is provided on a principal surface S1 of the conductive plate section 29 opposite to the principal surface S2.

A heater 111 is provided in the substrate section 11. The PM sensor 1 is configured such that when a large amount of PM 8 is deposited on the deposition surface 20, the heater 111 generates heat to burn and remove the PM 8.

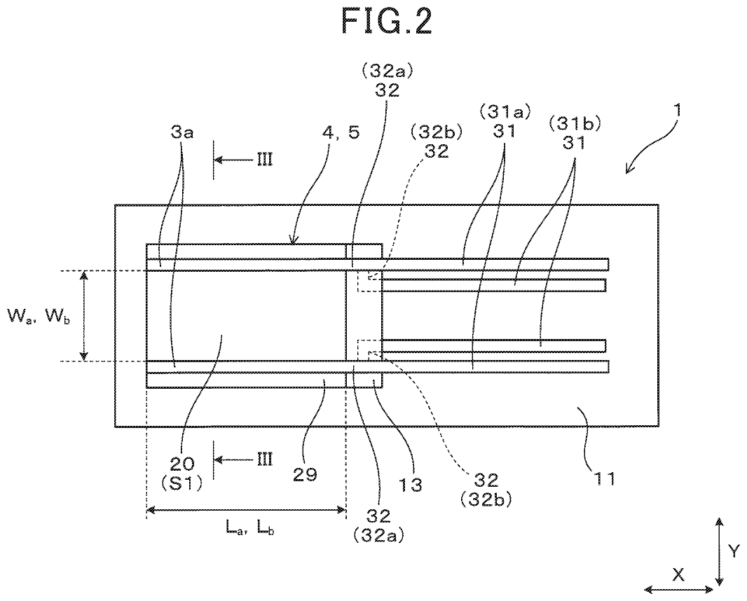

As illustrated in FIGS. 2 to 4, an interval Wₐ between the pair of detection electrodes 3a is equal to an interval W_{b} between the pair of monitor electrodes 3b. Furthermore, a length Lₐ of the electrodes 3a and a length L_{b} of the electrodes 3b in a longitudinal direction (X direction in FIGS. 2 to 4) are equal to each other.

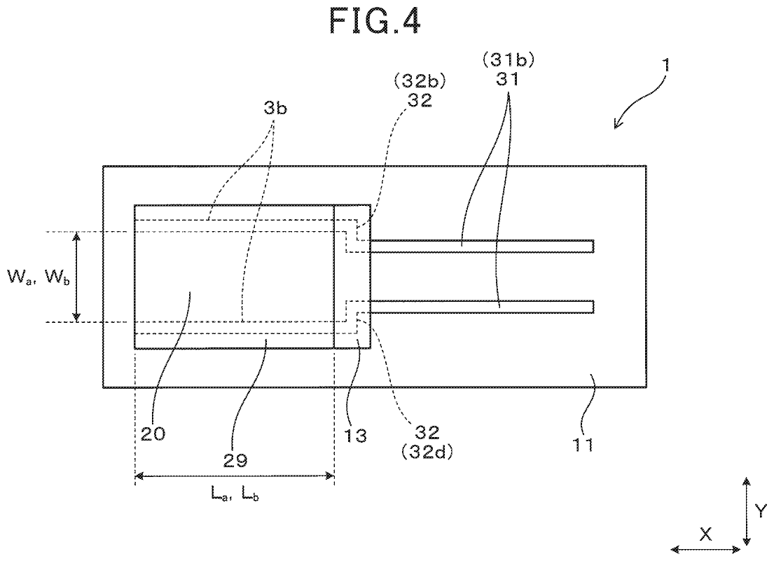

As illustrated in FIGS. 2 and 4, terminals 31 (i.e., detection terminals 31a) are connected to the respective detection electrodes 3a. Also, terminals 31 (i.e., monitor terminals 31b) are connected to the respective monitor electrodes 3b. The terminals 31a and 31b are connected to the detection circuit 60 (see FIG. 6). The monitor terminals 31b are arranged between the pair of detection terminals 31a.

Furthermore, an insulating section 13 made of an insulating material is arranged at a position adjacent to the conductive plate section 29. The detection electrodes 3a are coupled to the respective detection terminals 31a by respective detection coupling sections 32a. The monitor electrodes 3b are coupled to the respective monitor terminals 31b by respective monitor coupling sections 32b. The detection coupling sections 32a are provided on an outer surface of the insulating section 13, and the monitor coupling sections 32b are interposed between the insulating section 13 and the substrate section 11. An interval between the detection coupling sections 32a is larger than an interval between the monitor coupling sections 32b. In the present embodiment, the insulating section 13 is provided to prevent an electric current from flowing between the detection coupling sections 32a and between the monitor coupling sections 32b. Accordingly, in a state in which no PM 8 is deposited on the deposition surface 20, the electric current I flowing between the detection electrodes 3a is approximately equal to the electric current I flowing between the monitor electrodes 3b, and thus an electrical resistance between the detection electrodes 3a is approximately equal to an electrical resistance between the monitor electrodes 3b.

The PM detection apparatus 10 will be described below. As illustrated in FIG. 5, the PM detection apparatus 10 of the present embodiment includes the PM sensor 1 and the control section 6 connected to the PM sensor 1. The control section 6 includes the main measurement section 61, the compensation measurement section 62, and the deposition amount calculation section 63. The main measurement section 61 measures a particulate matter detection resistance R_{S} (see FIG. 6) which is an electrical resistance between the pair of detection electrodes 3a. The compensation measurement section 62 measures a compensation resistance R_{b} which is an electrical resistance between the pair of monitor electrodes 3b. The deposition amount calculation section 63 compensates for a change in the detection conductive section resistance Rₐ according to the temperature by using a measured value of the compensation resistance R_{b}, and calculates the amount of PM 8 deposited on the deposition surface 20.

For example, the deposition amount of PM 8 can be calculated as below. As illustrated in FIG. 6, a value of the particulate matter detection resistance R_{S} is determined by the detection conductive section resistance Rₐ and a resistance R_{PM} of the PM 8. For example, the particulate matter detection resistance R_{S} can be approximately expressed by the following equation.

R_{S}=R_{PM}Rₐ/(R_{PM}+Rₐ)

As described above, in the present embodiment, the detection conductive section resistance Rₐ is approximately equal to the compensation resistance R_{b}. Accordingly, the above equation can be transformed as below.

R_{S}=R_{PM}R_{b}(R_{PM}+R_{b})

Since R_{S} and R_{b} can be measured, the resistance R_{PM} of the PM 8 can be calculated by the above equation. Furthermore, in a case where a relationship between the resistance R_{PM} and the deposition amount of PM 8 is prestored, the deposition amount of PM 8 can be calculated from the calculated value of the resistance R_{PM}.

Alternatively, the deposition amount of PM 8 can also be calculated as below. FIG. 10 is a graph showing a change in electric current I_{S} between the detection electrodes 3a and a change in electric current I_{b} between the monitor electrodes 3b when the temperature is changed in a state in which a fixed amount of PM 8 is deposited on the deposition surface 20. The graph shows that a larger amount of electric current flows between the detection electrodes 3a than between the monitor electrodes 3b. This is because the PM 8 is deposited on the deposition surface 20 and thus the electric current flows through the PM 8 (see FIG. 8). Values of the electric currents I_{S} and I_{b} can be obtained by using the particulate matter detection resistance R_{S} and the compensation resistance R_{b}. The electric current I_{S} between the detection electrodes 3a can be approximately expressed as below by using an electric current Iₐ (see FIG. 6) flowing through the detection conductive section 2a and an electric current I_{PM} flowing through the PM 8

I_{S}=Iₐ+I_{IPM}

Furthermore, the electrical resistance of the detection conductive section 2a is approximately equal to the electrical resistance of the monitor conductive section 2b, and thus the electric current Iₐ flowing through the detection conductive section 2a is approximately equal to the electric current I_{b} flowing through the monitor conductive section 2b. Accordingly, the above equation can be transformed as below.

I_{S}=I_{b}+I_{PM}

From this equation, the electric current flowing through the PM 8 (also termed a PM current I_{PM} hereinafter) is expressed as below.

I_{PM}=I_{S}−I_{b}

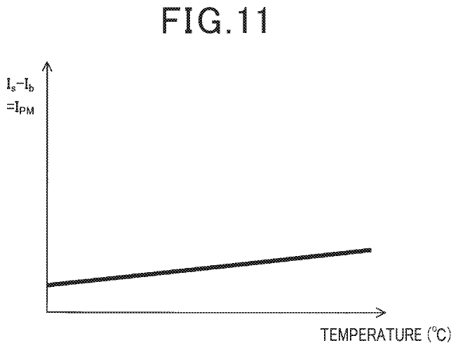

The calculated value of the PM current I_{PM} is a value obtained by removing the electric current Iₐ (=I_{b}) flowing through the detection conductive section 2a from the electric current I_{S} between the detection electrodes 3a. Accordingly, the PM current I_{PM} is hardly influenced by a change in the electrical resistance of the detection conductive section 2a according to the temperature. Thus, as shown in FIG. 11, even when the temperature is changed, the PM current I_{PM} is hardly changed. In a case where a relationship between a value of the PM current I_{PM} and the deposition amount of PM 8 is prestored, the deposition amount of PM 8 can be calculated.

As shown in FIG. 11, even if the deposition amount of PM 8 is constant, when the temperature is increased, the PM current I_{PM} is increased to some extent. This is because when the temperature is increased, the electrical resistance of the PM 8 itself is reduced. However, a rate of change in the electrical resistance R_{PM} of the PM 8 according to the temperature is relatively small, and thus even when the PM current I_{PM} is used, the deposition amount of PM 8 can be calculated with relatively high accuracy.

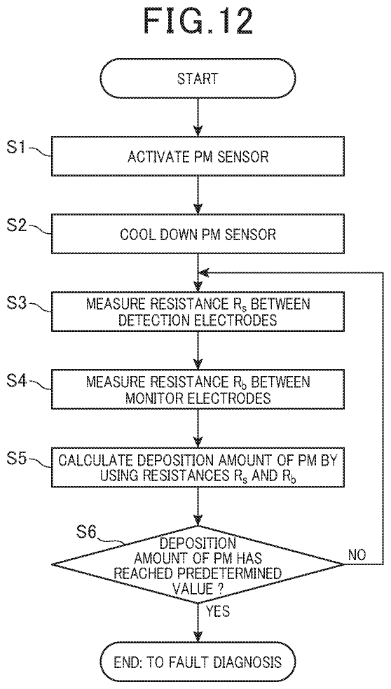

A flow chart for the control section 6 will be described below with reference to FIG. 12. When the deposition amount of PM 8 is calculated, the control section 6 first causes the heater 111 to generate heat to burn the PM 8 deposited on the deposition surface 20. Thus, the PM sensor 1 is activated (step S1). Subsequently, the PM sensor 1 is cooled down in a predetermined time period (step S2).

Next, the electrical resistance (i.e., the particulate matter detection resistance R_{S}) between the pair of detection electrodes 3a is measured (step S3). Subsequently, the electrical resistance (i.e., the compensation resistance R_{b}) of the monitor electrodes 3b is measured (step S4). Then, the deposition amount of PM 8 is calculated by using measured values of the resistances R_{S} and R_{b} (step S5).

After step S5, the control proceeds to step S6. In this step, it is determined whether the deposition amount of PM 8 has reached a predetermined value. In this step, if a negative determination (No) is made, the control returns to step S3. if an affirmative determination (Yes) is made, the process ends. Then, it is determined whether the purification device 73 (see FIG. 5) has failed. The determination is made on the basis of time t required until the deposition amount of PM 8 reaches the predetermined value. Specifically, if the time t is shorter than a predetermined upper limit value, it is determined that the purification device 73 has failed. If the time t is longer than the upper limit value, it is determined that the purification device 73 has not failed.

Effects of the present embodiment will be described below. As illustrated in FIGS. 1 and 3, the PM sensor 1 of the present embodiment includes the detection conductive section 2a provided with the deposition surface 20 and the pair of detection electrodes 3a facing each other across the deposition surface 20. The detection conductive section 2a is made of the conductive material having a higher electrical resistivity than that of PM.

Thus, as illustrated in FIG. 7, even when no PM is deposited on the deposition surface 20, the electric current I can flow between the pair of detection electrodes 3a. Furthermore, as illustrated in FIG. 8, when a small amount of PM 8 is deposited on the deposition surface 20, in the regions A1 of the deposition surface 20 in which no PM 8 is deposited, the electric current I flows through the detection conductive section 2a, and in the region A2 of the deposition surface 20 in which the PM 8 is deposited, the electric current I mainly flows through the PM 8 whose electrical resistivity is low. Accordingly, even when the deposition amount of PM 8 is small and no current path has been formed by the PM 8 between the detection electrodes 3a, an electric current can flow between the detection electrodes 3a. Furthermore, according to the deposition amount of PM 8, the electrical resistance R_{S} between the detection electrodes 3a is changed, and thus a value of the electric current I_{S} is changed. Therefore, even when a small amount of PM 8 is deposited, the deposition amount of PM 8 can be detected.

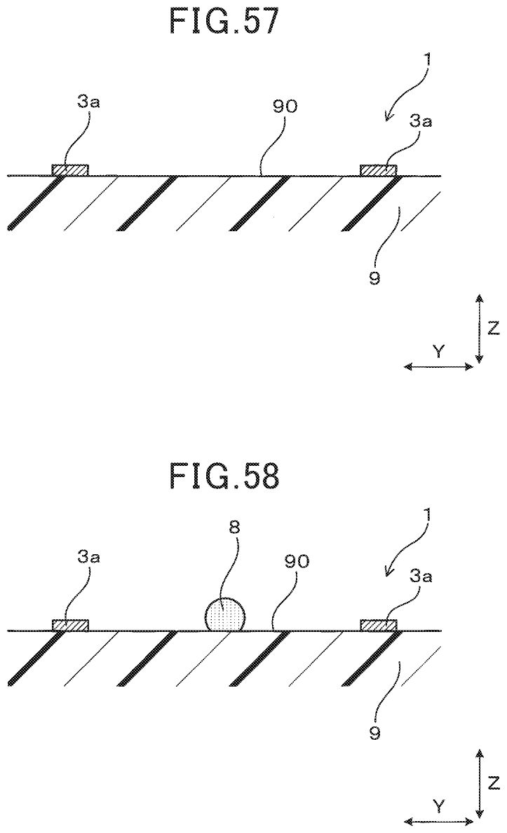

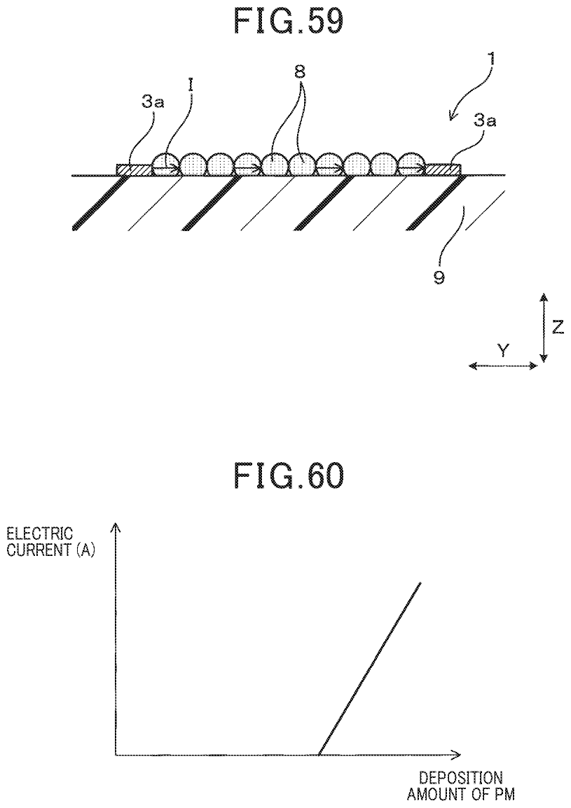

If, instead of the detection conductive section 2a made of the conductive material, as illustrated in FIGS. 57 and 58, an insulating plate 9 made of an insulating material is used to form a deposition surface 90 for the PM 8 on a surface of the insulating plate 9, when the deposition amount of PM 8 is small, the PM 8 cannot be detected. Specifically, since the insulating plate 9 is made of the insulating material, when the deposition amount of PM 8 is small, no electric current flows between the pair of detection electrodes 3a. As illustrated in FIG. 59, after a certain amount of PM 8 is deposited on the deposition surface 90 and a current path has been formed by the PM 8 between the detection electrodes 3a, the electric current I starts flowing between the detection electrodes 3a. Thus, as shown in FIG. 60, when the deposition amount of PM 8 is small, the PM 8 cannot be detected. On the other hand, as in the present embodiment, by using the detection conductive section 2a made of the conductive material, as illustrated in FIGS. 8 and 9, even when the deposition amount of PM 8 is small and no current path has been formed by the PM 8, the electric current I can flow between the detection electrodes 3a. Furthermore, the electric current I can be changed according to the deposition amount of PM 8. Therefore, even when the deposition amount of PM 8 is small, the deposition amount of PM 8 can be detected.

Furthermore, as illustrated in FIG. 3, the PM sensor 1 of the present embodiment includes the resistance monitor section 5. The resistance monitor section 5 includes the monitor conductive section 2b and the pair of monitor electrodes 3b provided in the monitor conductive section 2b.

Accordingly, it is possible to compensate for the change in the electrical resistance of the detection conductive section 2a according to the temperature. Thus, the deposition amount of PM can be accurately measured. Specifically, since the detection conductive section 2a is arranged at the position adjacent to the monitor conductive section 2b, the temperature of the detection conductive section 2a is almost equal to the temperature of the monitor conductive section 2b. Furthermore, since the resistance monitor section 5 is configured such that no PM is deposited on the monitor conductive section 2b, the electrical resistance (i.e., the compensation resistance R_{b}) of the monitor conductive section 2b between the monitor electrodes 3b is hardly influenced by the PM 8. Thus, by measuring the compensation resistance R_{b}, it is possible to calculate the electrical resistance Rₐ of the detection conductive section 2a at the same temperature as that of the monitor conductive section 2b.

As described above, the PM sensor 1 has a structure in which the electric current I between the detection electrodes 3a flows through the detection conductive section 2a, and the electrical resistance Rₐ of the detection conductive section 2a is greatly changed according to the temperature. In the present embodiment, since the electrical resistance Rₐ of the detection conductive section 2a can be obtained by measuring the compensation resistance R_{b}, it is possible to compensate for the change in the electrical resistance Rₐ according to the temperature. Thus, the deposition amount of PM 8 can be accurately obtained.

Furthermore, as illustrated in FIG. 5, the PM detection apparatus 10 of the present embodiment includes the PM sensor 1 and the control section 6 connected to the PM sensor 1. The control section 6 includes the main measurement section 61, the compensation measurement section 62, and the deposition amount calculation section 63.

Thus, the deposition amount of PM 8 can be accurately and reliably calculated.

Furthermore, as illustrated in FIG. 3, in the present embodiment, the detection conductive section 2a is integrated with the monitor conductive section 2b to constitute the single conductive plate section 29.

Accordingly, as compared with a case where the detection conductive section 2a and the monitor conductive section 2b are separately formed, the number of components can be reduced, and thus manufacturing cost of the PM sensor 1 can be reduced.

Furthermore, in the present embodiment, the principal surface S2 of the conductive plate section 29 in which the monitor electrodes 3b are provided is in contact with the substrate section 11.

Thus, the substrate section 11 can prevent the PM 8 from adhering between the monitor electrodes 3b.

Furthermore, as illustrated in FIG. 3, in the present embodiment, the heater 111 for burning the PM 8 deposited on the deposition surface 20 is provided in the substrate section 11.

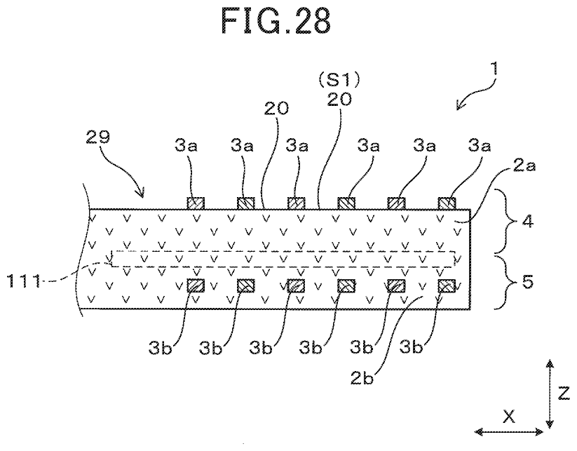

Thus, power consumption of the heater 111 can be reduced. Specifically, it is possible to provide the heater 111 inside the conductive plate section 29, without providing the substrate section 11 (see FIG. 28). In this case, however, the conductive plate section 29 itself needs to ensure rigidity of the whole PM sensor 1, and thus the conductive plate section 29 needs to have a sufficiently large thickness. Furthermore, the conductive material constituting the conductive plate section 29 is selected by placing priority on a good resistivity and temperature characteristic. Accordingly, a material having good thermal conductivity cannot be necessarily used. This makes it difficult to heat the deposition surface 20 by the heater 111, and thus power consumption of the heater 111 is more likely to be increased. On the other hand, as illustrated in FIG. 3, as in the present embodiment, when the substrate section 11 is provided, the substrate section 11 can ensure rigidity, and thus the conductive plate section 29 can have a small thickness. Furthermore, a material having good thermal conductivity can be selected as the material constituting the substrate section 11, and thus this facilitates heating of the deposition surface 20 by the heater 111 in the substrate section 11. Thus, power consumption of the heater 111 can be reduced.

Furthermore, as illustrated in FIG. 3, in the present embodiment, the interval Wₐ between the pair of detection electrodes 3a is equal to the interval W_{b} between the pair of monitor electrodes 3b.

Thus, the electrical resistance Rₐ of the detection conductive section 2a between the detection electrodes 3a can be equal to the electrical resistance (i.e., the compensation resistance R_{b}) of the monitor conductive section 2b between the monitor electrodes 3b. This facilitates calculation of the deposition amount of PM 8 by the deposition amount calculation section 63.

As has been described, the present embodiment can provide a particulate matter detection sensor capable of detecting a deposition amount of particulate matter even when the deposition amount of particulate matter is small, and easily preventing a change in detection value according to a temperature, and a particulate matter detection apparatus including the particulate matter detection sensor.

In the following embodiments, reference signs in the drawings same as those used in the first embodiment indicate components or the like similar to those in the first embodiment, unless particularly stated.

### Second Embodiment

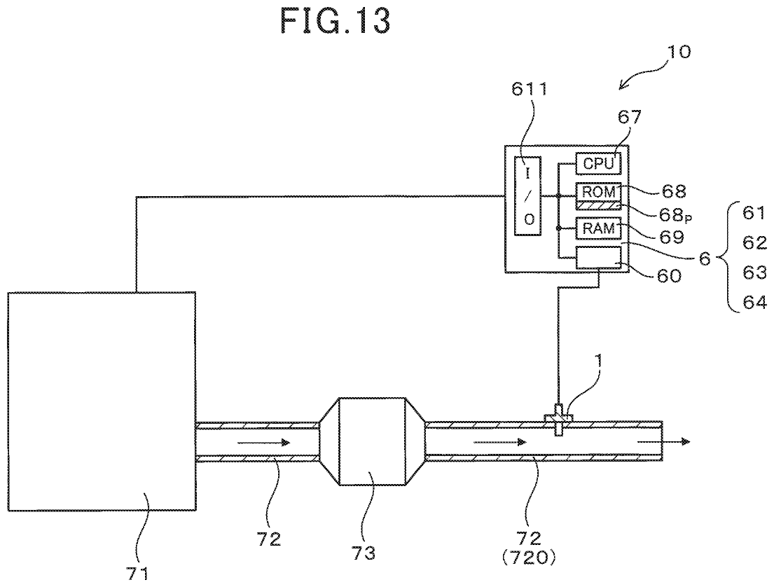

The present embodiment is an example in which the configuration of the control section 6 is modified. As illustrated in FIG. 13, as with the first embodiment, the control section 6 of the present embodiment includes the main measurement section 61, the compensation measurement section 62, and the deposition amount calculation section 63. In addition, the control section 6 further includes a temperature calculation section 64.

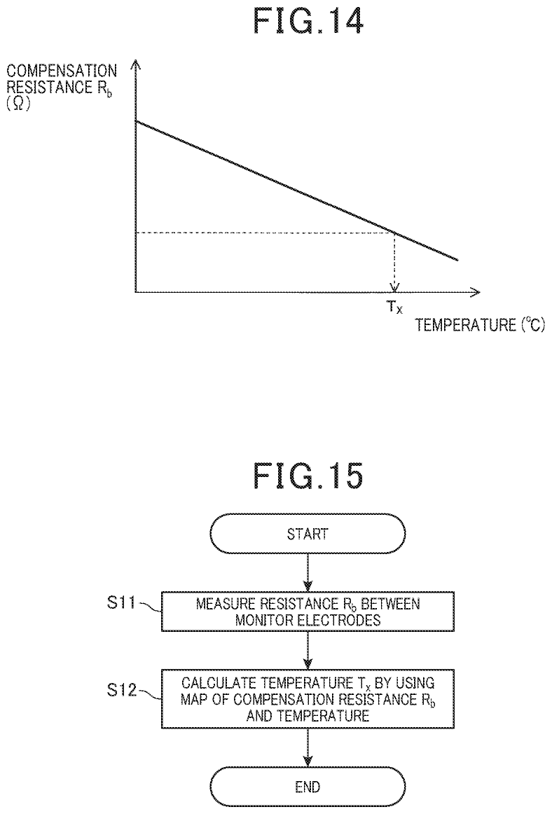

The temperature calculation section 64 calculates the temperature of the detection conductive section 2a by using a measured value of the compensation resistance R_{b}. As shown in FIG. 14, the compensation resistance R_{b} has a certain relationship with the temperature. The control section 6 stores the relationship. The relationship is used to calculate a temperature Tₓ from a measured value of the compensation resistance R_{b}. For example, the calculated value of the temperature Tₓ can be used to determine whether when the heater 111 has generated heat, the detection conductive section 2a has sufficiently been heated and the PM 8 has been burned.

FIG. 15 shows a flow chart for the temperature calculation section 64. As illustrated in FIG. 15, the temperature calculation section 64 first applies a voltage between the monitor electrodes 3b and measures the compensation resistance R_{b} (step S11). Subsequently, the temperature calculation section 64 calculates the temperature Tₓ by using a map of the compensation resistance R_{b} and the temperature (step S12).

Effects of the present embodiment will be described. According to the present embodiment, the temperature of the detection conductive section 2a can be obtained by using the resistance monitor section 5. Accordingly, a dedicated temperature sensor is not required, and thus manufacturing cost of the PM sensor 1 can be reduced.

Other than this, the second embodiment has a configuration and effects similar to those of the first embodiment.

### Third Embodiment

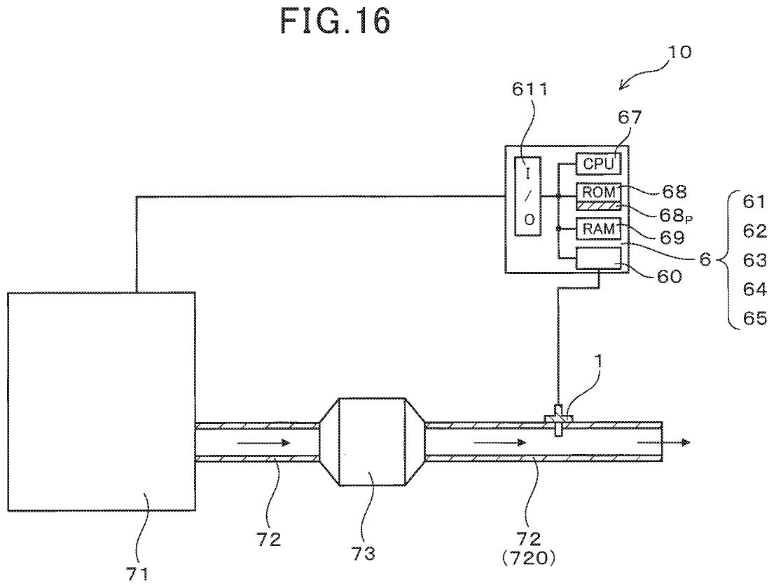

The present embodiment is an example in which the configuration of the control section 6 is modified. As illustrated in FIG. 16, as with the second embodiment, the control section 6 of the present embodiment includes the main measurement section 61, the compensation measurement section 62, the deposition amount calculation section 63, and the temperature calculation section 64. In addition, the control section 6 further includes a deposition amount correction section 65. The deposition amount correction section 65 corrects a change in resistivity of the PM 8 according to the temperature by using a value of the temperature Tₓ calculated by the temperature calculation section 64. Thus, the deposition amount correction section 65 corrects the deposition amount of PM 8 calculated by the deposition amount calculation section 63.

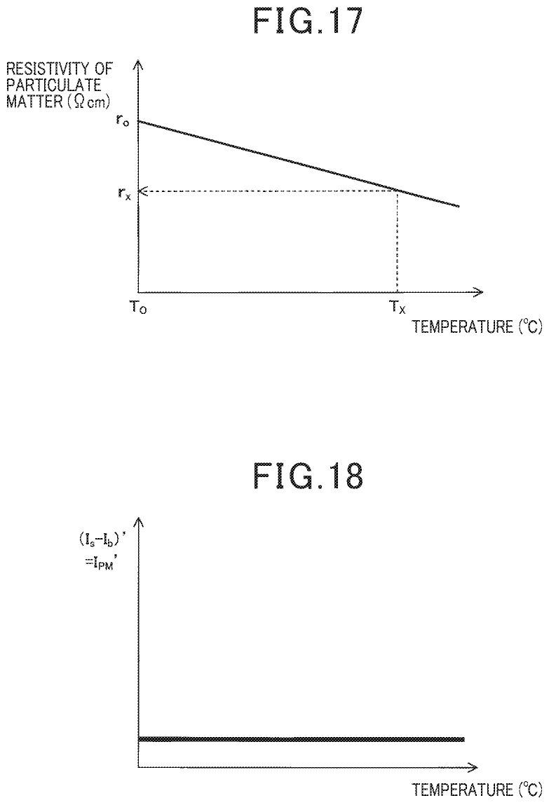

For example, the correction of the deposition amount can be performed as below. As shown in FIG. 17, the resistivity of the PM 8 has a certain relationship with the temperature. The relationship is prestored in the control section 6. Then, the relationship is used to obtain a resistivity rₓ of the PM 8 at the measured temperature Tₓ. Furthermore, a ratio rₒ/rₓ of a resistivity rₒ of the PM 8 at an ordinary temperature Tₒ and the resistivity rₓ at the temperature Tₓ is calculated.

A resistance value R_{PM} at the temperature Tₓ and a resistance value R_{PM}′ at the ordinary temperature of the whole PM 8 deposited on the deposition surface 20 have the following relationship.

R_{PM}′=R_{PM}rₒ/rₓ

Furthermore, the electric current (i.e., the PM current I_{PM}) flowing through the PM 8, the applied voltage Vₒ, and the resistance R_{PM} of the PM 8 have the following relationship.

I_{PM}=V_{O}/R_{PM}

The PM current I_{PM} at the temperature Tₓ can be converted into a value I_{PM}′ at the ordinary temperature by using the following equation.

$$\begin{matrix}{I}_{PM}^{′} = {V}_{O} / {R}_{PM}^{′} \\ = {V}_{O} {r}_{x} / {R}_{PM} {r}_{o} \\ = {I}_{PM} {r}_{x} / {r}_{o}\end{matrix}$$

FIG. 18 shows a relationship between the corrected PM current I_{PM}′ and the temperature. The value I_{PM}′ is a value obtained by compensating for the change in resistivity of the PM 8 according to the temperature, and is thus constant regardless of the temperature. Accordingly, by using the value I_{PM}′, the deposition amount of PM 8 can be accurately calculated without being greatly influenced by the temperature.

The deposition amount of PM 8 can be directly calculated by using a calculated value of the PM current I_{PM} (see FIG. 11). However, the PM current I_{PM} is influenced by the change in resistivity of the PM 8 according to the temperature, and this may prevent sufficiently accurate calculation of the deposition amount of PM 8. On the other hand, as shown in FIG. 18, when the value I_{PM}′ is calculated by correcting the change in resistivity of the PM 8 according to the temperature, the value I_{PM}′ is hardly influenced by the temperature. Thus, the deposition amount of PM 8 can be sufficiently accurately calculated.

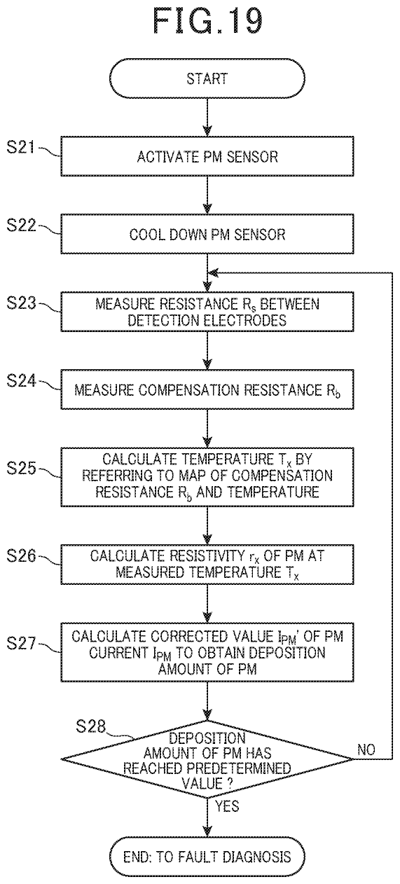

A flow chart for the control section 6 will be described below. As shown in FIG. 19, when the deposition amount of PM 8 is measured, the control section 6 first causes the heater 111 to generate heat to burn the PM 8. Thus, the PM sensor 1 is activated (step S21). Subsequently, the PM sensor 1 is cooled down in a predetermined time period (step S22).

Next, the control proceeds to step S23, and the electrical resistance R_{S} between the detection electrodes 3a is measured. Subsequently, the control proceeds to step S24, and a voltage is applied between the monitor electrodes 3b, and the compensation resistance R_{b} is measured. Subsequently, the control proceeds to step S25. In this step, the temperature Tₓ is calculated by using the map of the compensation resistance R_{b} and the temperature (see FIG. 14).

Next, the control proceeds to step S26. At this step, the resistivity rₓ of the PM 8 at the measured temperature Tₓ is calculated by using the map of the resistivity of the PM 8 and the temperature (see FIG. 17). Subsequently, step S27 is performed. In this step, the corrected value I_{PM}′ of the PM current I_{PM} (=I_{S}-I_{b}) is calculated. Then, the deposition amount of PM 8 is calculated by using the obtained corrected value I_{PM}′.

Next, the control proceeds to step S28. In this step, it is determined whether the deposition amount of PM 8 has reached a predetermined value. In this step, if a negative determination (No) is made, the control proceeds to step S23, and if an affirmative determination (Yes) is made, the process ends.

Other than this, the third embodiment has a configuration and effects similar to those of the first embodiment.

### First Experiment Example

An experiment was conducted in order to determine a preferable range of an interval H (see FIG. 3) between the detection electrode 3a and the monitor electrode 3b in the Z direction. First, a plurality of samples of the PM sensor 1 having the structure described in the first embodiment were prepared. In this case, the intervals H of the samples were set to 4 μm, 8 μm, 10 μm, 20 μm, 40 μm, 45 μm, 50 μm, 80 μm, and 100 μm. Furthermore, the PM sensor 1 in which the detection electrodes 3a also serves as the monitor electrodes 3b was prepared as a substitute for a sample in which the interval H was 0 μm. RuO₂-based glass having a resistivity of 6×10⁶ Ω·cm was used for the conductive plate section 29 of each of the samples. The interval Wₐ between the detection electrodes 3a and the interval W_{b} between the monitor electrodes 3b were each set to 700 μm, and the length Lₐ of the electrodes 3a and the length L_{b} of the electrodes 3b were each set to 8 mm.

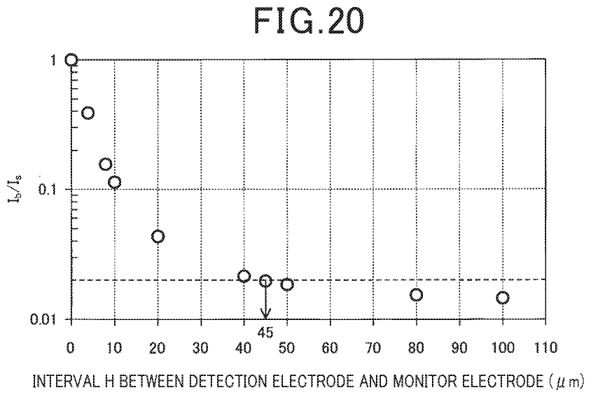

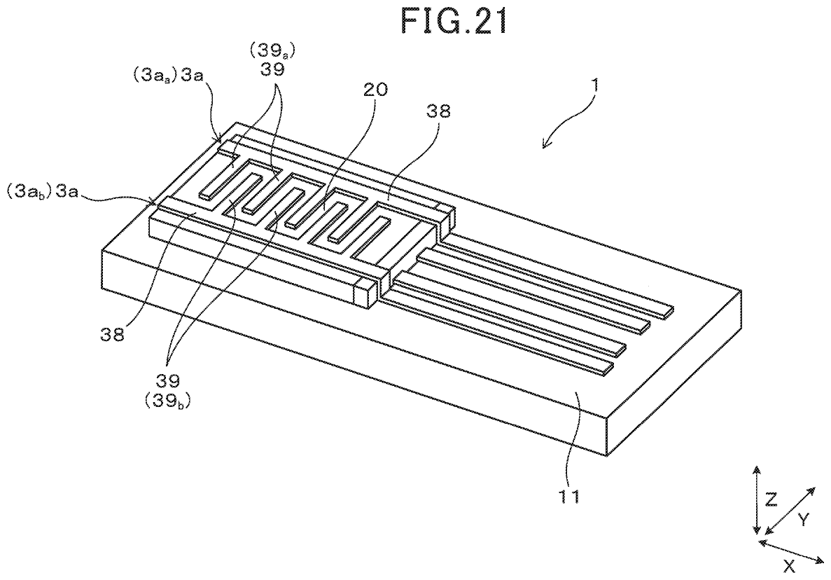

After the samples were prepared, the PM 8 was deposited on the deposition surface 20 of each of the samples, and the electric current I_{b} flowing between the pair of monitor electrodes 3b and the electric current I_{S} flowing between the pair of detection electrodes 3a were measured. More specifically, in a state in which approximately 120 ng of PM 8 was deposited on the deposition surface 20 and the temperature was set to 200° C., a voltage of 1 kV was applied between the electrodes, and the electric currents I_{b} and I_{S} were measured. FIG. 20 shows a relationship between a ratio I_{b}/I_{S} of the measured electric currents I_{b} and I_{S} and the interval H.

As shown in FIG. 20, as the interval H becomes narrower, the ratio I_{b}/I_{S} is increased. This is because when the interval H is narrower, the monitor electrodes 3b are located closer to the deposition surface 20, and thus the electric current I_{b} flows from one of the monitor electrodes 3b to the other of the monitor electrode 3b thorough the PM 8 whose resistivity is low, and this causes the electric current I_{b} to have a larger value. Furthermore, the graph in FIG. 20 shows that when the interval H is wider, the monitor electrodes 3b are located more distant from the deposition surface 20, and thus the electric current I_{b} is less likely to flow through the PM 8, and this causes the electric current I_{b} to have a smaller value.

Furthermore, the graph in FIG. 20 shows that when the ratio I_{b}/I_{S} is 0.02 or less, the ratio I_{b}/I_{S} is not greatly changed even if the interval H becomes wider. This is presumably because the electric current I_{b} hardly flows through the PM 8, and thus even when the interval H becomes wider, the electric current I_{b} is not reduced. Accordingly, in a case where the ratio I_{b}/I_{S} has been set to 0.02 or less, even if manufacturing variations occur in the interval H, i.e., the thickness of the conductive plate section 29, the electric current I_{b} can be accurately measured, and thus the compensation resistance R_{b} can be accurately measured. This makes it possible to accurately compensate for the change in the electrical resistance Rₐ of the detection conductive section 2a according to the temperature.

Other than this, the first experiment example has a configuration and effects similar to those of the first embodiment.

### Fourth Embodiment

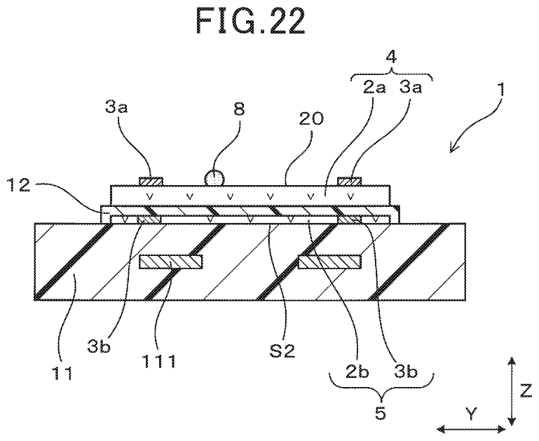

The present embodiment is an example in which the shapes of the detection electrodes 3a and the monitor electrodes 3b are modified. As illustrated in FIG. 21, the detection electrodes 3a of the present embodiment each include a body portion 38 and comb tooth sections 39 protruding from the body portion 38. Comb tooth sections 39ₐ of a detection electrode 3aₐ, which is one of the detection electrodes 3a, and comb tooth sections 39_{b} of a detection electrode 3a_{b}, which is the other of the detection electrodes 3a, are alternately arranged. The monitor electrodes 3b also have similar shapes.

Effects of the present embodiment will be described. The above configuration achieves a narrow interval between the pair of detection electrodes 3aₐ and 3a_{b} while ensuring a broad area of the deposition surface 20. Thus, even when a small amount of PM 8 is deposited on the deposition surface 20, the electric current I_{S} between the detection electrodes 3a a and 3a b can be greatly changed. This achieves high detection sensitivity for the PM 8.

Other than this, fourth embodiment has a configuration and effects similar to those of the first embodiment.

### Fifth Embodiment

The present embodiment is an example in which the structure of the PM sensor 1 is modified. As illustrated in FIG. 22, in the present embodiment, the detection conductive section 2a is a member separate from the monitor conductive section 2b. The monitor conductive section 2b is covered with an insulating film 12. The detection conductive section 2a is arranged on the insulating film 12. Furthermore, the principal surface S2 of the monitor conductive section 2b is in contact with the substrate section 11. The principal surface S2 is a surface of the monitor conductive section 2b on the side opposite to the side on which the detection conductive section 2a is provided.

Effects of the present embodiment will be described. In the present embodiment, the insulating film 12 is interposed between the detection conductive section 2a and the monitor conductive section 2b. Accordingly, the monitor electrodes 3b are insulated from the PM 8, and thus even when a voltage is applied between the pair of monitor electrodes 3b, the electric current I_{b} does not flow through the PM 8. Thus, the compensation resistance R_{b} can be accurately measured. This makes it possible to accurately compensate for the change in the electrical resistance Rₐ of the detection conductive section 2a according to the temperature.

Other than this, the fifth embodiment has a configuration and effects similar to those of the first embodiment.

### Sixth Embodiment

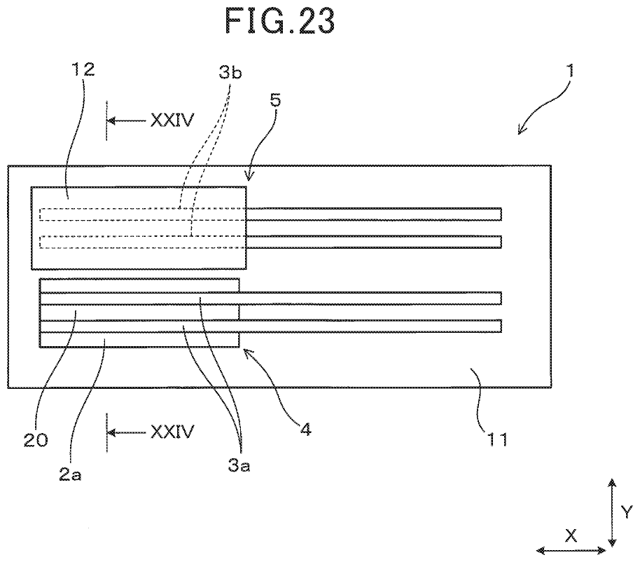

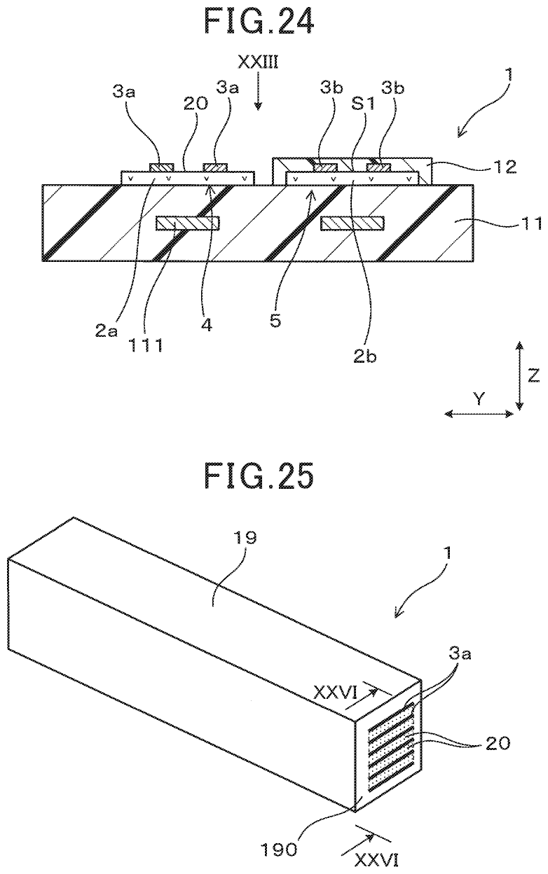

The present embodiment is an example in which the configuration of the PM sensor 1 is modified. As illustrated in FIGS. 23 and 24, in the present embodiment, the detection conductive section 2a is separated from the monitor conductive section 2b. The conductive sections 2a and 2b each have a plate shape and are provided on the substrate section 11.

The monitor electrodes 3b are provided on the principal surface 51 of the monitor conductive section 2b which is opposite to a principal surface of the monitor conductive section 2b in contact with the substrate section 11. The monitor conductive section 2b and the monitor electrodes 3b are covered with the insulating film 12.

Effects of the present embodiment will be described. The above configuration enables the particulate matter detection section 4 and the resistance monitor section 5 to have the same shape. Thus, the detection conductive section resistance Rₐ is more likely to be equal to the compensation resistance R_{b}. This enables accurate temperature compensation.

Other than this, sixth embodiment 6 has a configuration and effects similar to those of the first embodiment.

### Seventh Embodiment

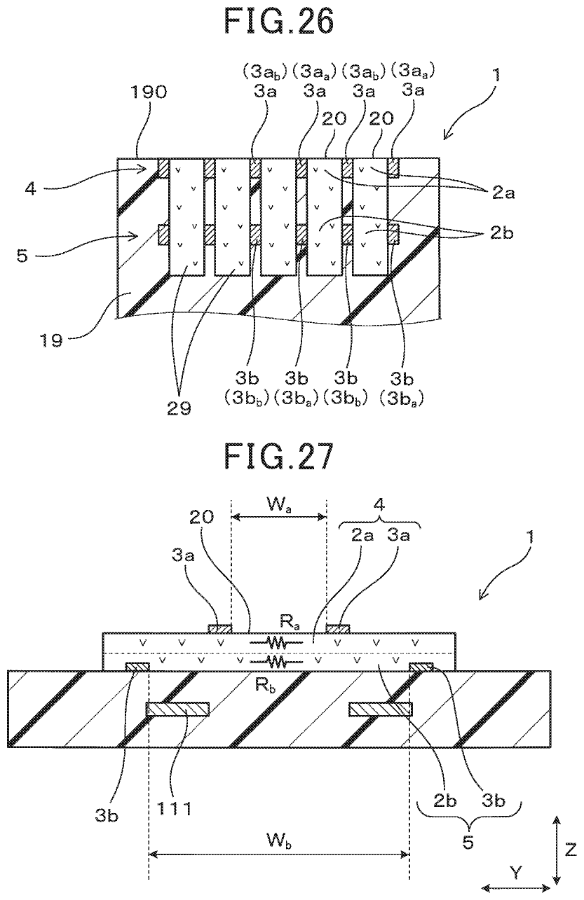

The present embodiment is an example in which the configuration of the PM sensor 1 is modified. As illustrated in FIGS. 25 and 26, the PM sensor 1 of the present embodiment includes a sensor body portion 19 made of an insulating material. A plurality of conductive plate sections 29 are arranged in the sensor body portion 19. The conductive plate sections 29 are each made of a conductive material having a higher electrical resistivity than that of the PM 8. The plurality of conductive plate sections 29 are laminated. As illustrated in FIG. 26, the detection electrode 3a and the monitor electrode 3b are interposed between two adjacent ones of the conductive plate sections 29. The detection electrodes 3a and the conductive plate sections 29 are exposed from an end face 190 of the sensor body portion 19. The deposition surfaces 20 for the PM 8 are the exposed surfaces of the conductive plate sections 29.

The detection electrodes 3a are divided into first detection electrodes 3aₐ and second detection electrodes 3a_{b}. The first detection electrodes 3aₐ and the second detection electrodes 3a_{b} are alternately arranged. By connecting members (not illustrated), the plurality of first detection electrodes 3aₐ are electrically connected to each other, and the plurality of second detection electrodes 3a_{b} are electrically connected to each other. Furthermore, the monitor electrodes 3b also have similar structures.

Effects of the present embodiment will be described. The above configuration achieves a narrow interval between the two detection electrodes 3aₐ and 3a_{b}. Thus, even when a small amount of PM 8 is deposited on the deposition surface 20, the electric current I_{S} of the detection electrodes 3aₐ and 3a_{b} is likely to be greatly changed. This achieves high detection sensitivity for the PM 8.

Other than this, the seventh embodiment has a configuration and effects similar to those of the first embodiment.

### Eighth Embodiment

The present embodiment is an example in which the structure of the PM sensor 1 and the method of calculating the deposition amount of PM 8 are modified. As illustrated in FIG. 27, in the present embodiment, the interval Wₐ between the pair of detection electrodes 3a differs from the interval W_{b} between the pair of monitor electrodes 3b. Furthermore, the deposition amount calculation section 63 is configured to calculate the deposition amount of PM 8 by using a value R_{b}Wₐ/W_{b} obtained by multiplying a measured value of the compensation resistance R_{b} by a ratio Wₐ/W_{b} of the interval Wₐ between the detection electrodes 3a and the interval W_{b} between the pair of monitor electrodes 3b.

For example, the deposition amount of PM 8 can be calculated as below. As described above, the electrical resistance R_{S} between the pair of detection electrodes 3a can be approximately expressed as below by using the resistance R_{PM} of the PM 8 and the resistance Rₐ of the detection conductive section 2a.

R_{S}=R_{PM}Rₐ/(R_{PM}+Rₐ) (1)

Furthermore, a relationship between the resistance Rₐ and the compensation resistance R_{b} can be expressed as below.

Rₐ=R_{b}Wₐ/W_{b} (2)

Accordingly, the resistance R_{PM} of the PM 8 can be calculated by the equations (1) and (2), and thus the deposition amount of PM 8 can be calculated.

Effects of the present embodiment will be described. In the present embodiment, the interval Wₐ between the pair of detection electrodes 3a differs from the interval W_{b} between the pair of monitor electrodes 3b. This increases the degree of freedom in designing the PM sensor 1. Furthermore, a distance from the monitor electrodes 3b to the deposition surface 20 can be made longer, and thus the electric current I_{b} between the monitor electrodes 3b is less likely to flow through the PM 8 deposited on the deposition surface 20. This facilitates accurate measurement of the compensation resistance R_{b}.

Other than this, the eighth embodiment has a configuration and effects similar to those of the first embodiment.

### Ninth Embodiment

The present embodiment is an example in which the configuration of the PM sensor 1 is modified. As illustrated in FIG. 28, unlike the first embodiment, the PM sensor 1 of the present embodiment does not include the substrate section 11 (see FIG. 3). In the present embodiment, as with the first embodiment, the detection conductive section 2a is integrated with the monitor conductive section 2b to constitute the single conductive plate section 29. The heater 111 for burning the PM 8 is provided in the conductive plate section 29.

Furthermore, the deposition surface 20 on which the PM 8 is deposited and the pair of detection electrodes 3a are provided on the principal surface S1 of the conductive plate section 29. As with the fourth embodiment, the detection electrodes 3a of the present embodiment are arranged to form a comb tooth shape. Furthermore, the monitor electrodes 3b are provided in the conductive plate section 29. Similarly to the detection electrodes 3a, the monitor electrodes 3b are arranged to form a comb tooth shape.

Effects of the present embodiment will be described. Since the substrate section 11 is not used in the present embodiment, the number of components can be reduced. Thus, manufacturing cost of the PM sensor 1 can be reduced. Furthermore, as in the first embodiment, in the PM sensor 1 in which the conductive plate section 29 and the substrate section 11 are laminated, the conductive plate section 29 and the substrate section 11 have different thermal expansion coefficients, and thus when the heater 111 is heated, warpage of the PM sensor 1, peel-off of the conductive plate section 29, or the like may occur. In the present embodiment, however, since the substrate section 11 is not used, such a problem is less likely to occur.

Other than this, the ninth embodiment has a configuration and effects similar to those of the first embodiment.

### Tenth Embodiment

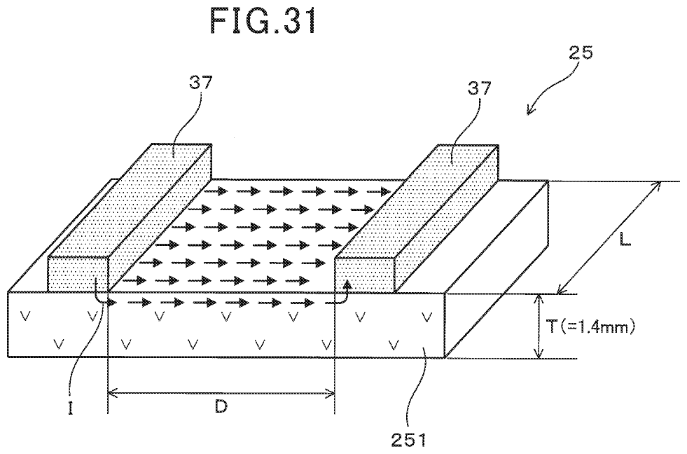

The present embodiment is an example in which the conductive material of the conductive sections 2a and 2b is modified. In the present embodiment, a surface electrical resistivity ρ of the conductive material is measured as below. Specifically, first, a sample 25 illustrated in FIG. 31 is prepared. The sample 25 includes a plate-shaped substrate 251 that is made of a conductive material and has a thickness T of 1.4 mm and a pair of measurement electrodes 37 that are provided on a main surface of the plate-shaped substrate 251, have a length of L, and are provided at an interval of D. Thus, the sample 25 is formed, and an electrical resistance R (Ω) between the pair of measurement electrodes 37 is measured. The surface electrical resistivity ρ is calculated by equation (3) below.

ρ=R×L×T/D (3)

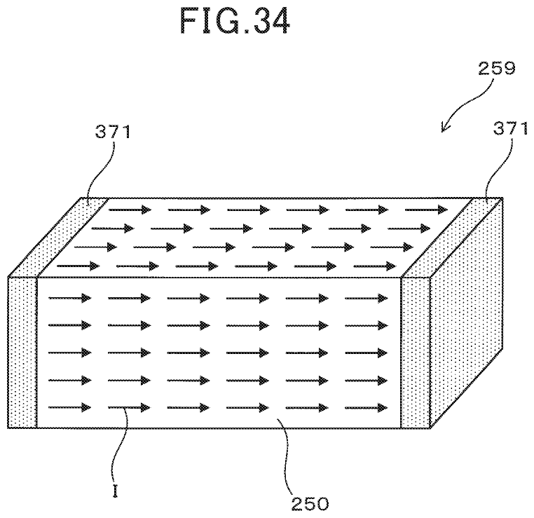

Herein, the “electrical resistivity” merely means what is termed a bulk electrical resistivity. For example, as illustrated in FIG. 34, the bulk electrical resistivity can be calculated by preparing a bulk sample 259 including a substrate section 250 made of a conductive material and a pair of measurement electrodes 371 provided on respective lateral surfaces of the substrate section 250, and measuring an electrical resistance between the pair of measurement electrodes 371. Furthermore, the “surface electrical resistivity ρ” means a value calculated, by equation (3), by preparing the sample 25 illustrated in FIG. 31, and measuring the electrical resistance R between the measurement electrodes 37.

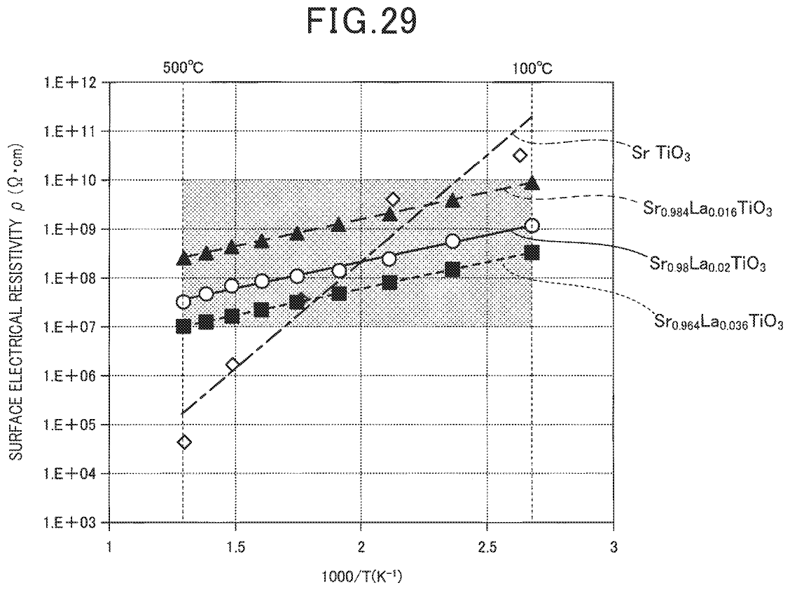

In the present embodiment, as shown in FIG. 29, the detection conductive section 2a and the monitor conductive section 2b are made of a conductive material having a surface electrical resistivity ρ in a range of 1.0×10⁷ to 1.0×10¹⁰ Ω·cm at a temperature range of 100 to 500° C.

As the conductive material having a surface electrical resistivity ρ satisfying the above numerical range, ceramic having a molecular formula of ABO₃ and having a perovskite structure can be used. For example, at least one selected from La, Sr, Ca, and Mg may be used as A in the molecular formula, and at least one selected from Ti, Al, Zr, and Y may be used as B in the molecular formula.

In the present embodiment, A in the molecular formula contains Sr as a main component and La as an accessory component. Furthermore, B in the molecular formula is Ti. FIG. 29 shows a relationship between the surface electrical resistivity ρ of the ceramic (Sr₁₋ₓLaₓTiO₃) and the temperature. As shown in FIG. 29, when X is 0.016 to 0.036, the surface electrical resistivity ρ of Sr₁₋ₓLaₓTiO₃ is in the range of 1.0×10⁷ to 1.0×10¹⁰ ° Ω·cm at the temperature range of 100 to 500° C. Thus, the ceramic can be appropriately used as the material for constituting the conductive sections 2a and 2b.

Furthermore, as shown in FIG. 29, when no La is added (SrTiO₃), the surface electrical resistivity ρ is in a range of approximately 1.0×10⁵ to 1.0×10¹¹ Ω·cm at the temperature range of 100 to 500° C. This shows that the ceramic containing La has a smaller amount of change in the surface electrical resistivity ρ according to the temperature.

More specifically, the graph in FIG. 29 is obtained by measuring the surface electrical resistivity ρ as below. That is, different types of ceramics in which X in Sr₁₋ₓLaₓTiO₃ is 0, 0.016, 0.02, and 0.36 are prepared, and the samples 25 (see FIG. 31) are prepared by using the different types of ceramics. The samples 25 each include the plate-shaped substrate 251 having a thickness T of 1.4 mm and the pair of measurement electrodes 37 that are provided on the main surface of the plate-shaped substrate 251, have a length L of 16 mm, and are provided at an interval D of 800 μm. The samples 25 are heated to the range of 100 to 500° C. in air. Then, a voltage in a range of 5 to 1000 V is applied between the measurement electrodes 37, and the electrical resistance R is measured. Then, the surface electrical resistivity ρ is calculated by equation (3).

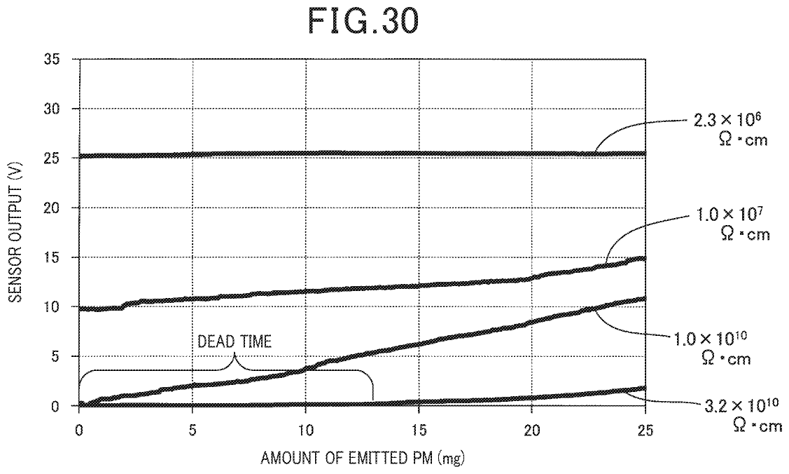

FIG. 30 shows a graph of a relationship between the amount of PM 8 emitted to the PM sensor 1 and sensor output of the PM sensor 1 obtained by changing the surface electrical resistivity ρ of the detection conductive section 2a. The graph is obtained as below. First, the conductive plate sections 29 are formed by using conductive materials having surface electrical resistivities ρ of 2.3×10⁶, 1.0×10⁷, 1.0×10¹⁰, and 3.2×10¹⁰ Ω·cm, and the PM sensors 1 (see FIG. 1) including the respective conductive plate sections 29 are prepared. Then, exhaust gas containing the PM 8 of 0.01 mg/l is emitted to each of the PM sensors 1, so that part of the emitted PM 8 is deposited on the deposition surface 20 of the PM sensors 1. Furthermore, the electric current I flowing between the pair of detection electrodes 3a is converted into a voltage by means of a shunt resistor to obtain the sensor output. The interval between the pair of detection electrodes 3a is 80 μm, applied voltage is 35 V, and a measured temperature is 200° C. FIG. 30 shows a graph of the relationship between the amount of emitted PM 8 and the sensor output.

As shown in FIG. 30, when the surface electrical resistivity ρ of the detection conductive section 2a is the range of 1.0×10⁷ to 1.0×10¹⁰ Ω·cm, the emission of only a small amount of PM 8 increases the sensor output of the PM sensor 1. This shows that the PM sensor 1 has high sensitivity. Furthermore, as the PM 8 adhered, the sensor output is greatly changed. This shows that when the surface electrical resistivity ρ of the detection conductive section 2a is within the above range, the PM sensor 1 has high sensitivity, and the amount of deposited PM 8 can be accurately measured.

On the other hand, when the surface electrical resistivity ρ is out of the above range, such an effect cannot be sufficiently obtained. For example, when the surface electrical resistivity ρ is 3.2×10¹⁰ Ω·cm, if the deposition amount of PM 8 is small, the sensor output is hardly increased. Specifically, dead time is present. This is presumably due to the following reason. That is, the surface electrical resistivity ρ of the conductive section 2 is excessively high, and thus the electric current I is less likely to flow between the detection electrodes 3a. Accordingly, the electric current I starts flowing after a large amount of PM is deposited and a current path has been formed by the PM 8.

Furthermore, for example, when the surface electrical resistivity ρ is 2.3×10⁶ Ω·cm, even if the deposition amount of PM 8 is changed, the sensor output is hardly changed. This is presumably due to the following reason. That is, the surface electrical resistivity ρ is excessively low, and thus even when the PM 8 is deposited, a large amount of electric current I does not flow through the PM 8. Accordingly, a value of the electric current between the detection electrodes 3a is less likely to be changed. This shows that, in this case, it is difficult to accurately measure the deposition amount of PM 8 by using the sensor output.

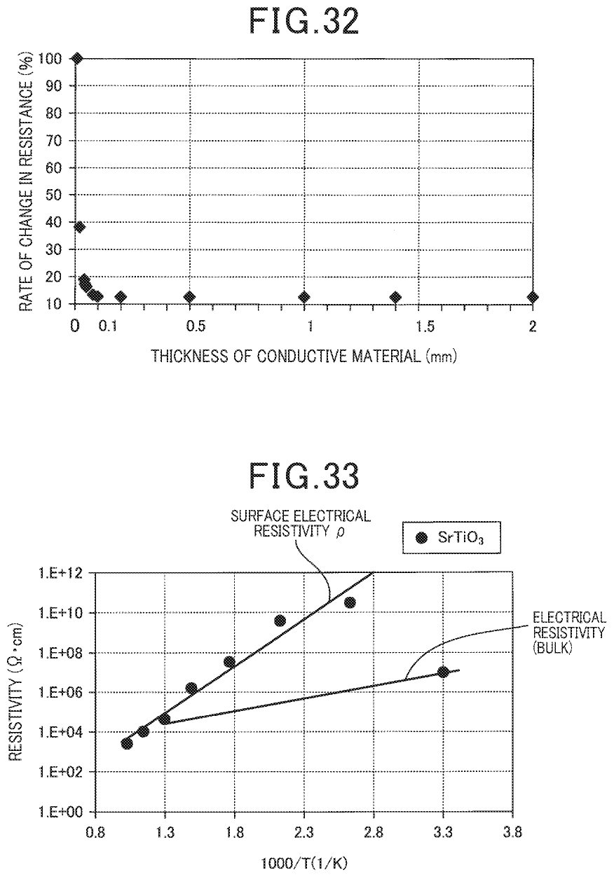

The depth, from a surface, of the electric current I flowing in the sample 25 (see FIG. 31) will be described below with reference to FIG. 32. The graph in FIG. 32 is obtained as below. First, the conductive material is formed into a sheet. Then, the measurement electrodes 37 are printed on a surface of the conductive material, and the conductive material are fired to prepare the samples 25. The thicknesses T of the samples 25 are set to 10 μm, 20 μm, 40 μm, 45 μm, 50 μm, 80 μm, 0.1 mm, 0.2 mm, 0.5 mm, 1.0 mm, 1.4 mm, and 2.0 mm. In order to eliminate influence of water, the samples 25 are heated to 200° C. Then, a voltage of 500 V is applied between the pair of measurement electrodes 37, and the electrical resistance R is measured. The measurement electrodes 37 have a length L of 16 mm and are provided at an interval D of 800 μm. The graph in FIG. 32 shows a relationship between a thickness of each of the samples 25 and a ratio of the electrical resistance R of the corresponding one of the samples 25 relative to the electrical resistance of the sample 25 having a thickness of 10 μm (i.e., 100%).

As shown in FIG. 32, when the sample 25 has a thickness in a range of 10 μm to 0.1 mm, as the thickness is increased, the electrical resistance is reduced. When the thickness exceeds 0.1 mm, however, the electrical resistance is hardly changed. This shows that the electric current I flows only at a depth of 0.1 mm or less from the surface of the sample 25. In the present embodiment, when the surface electrical resistivity ρ is measured, the sample 25 having a thickness T of 1.4 mm is used. This ensures a thickness sufficient for the electric current I to flow.

A relationship between each of the electrical resistivity and the surface electrical resistivity ρ of SrTiO₃ and temperature will be described below with reference to FIG. 33. The graph in FIG. 33 is obtained as below. Specifically, the sample 25 (see FIG. 31) is prepared by using SrTiO₃, and the surface electrical resistivity ρ is measured while the temperature is changed. Furthermore, the bulk sample 259 (see FIG. 34) is prepared by using SrTiO₃, and the bulk electrical resistivity is measured while the temperature is changed. The graph in FIG. 33 shows a relationship between each of the measured electrical resistivity and the surface electrical resistivity ρ, and the temperature. FIG. 33 shows that a value of the bulk electrical resistivity completely differs from a value of the surface electrical resistivity ρ.

Effects of the present embodiment will be described below. In the present embodiment, the conductive sections 2a and 2b are made of the conductive material having a surface electrical resistivity ρ in the range of 1.0×10⁷ to 1.0×10¹⁰ Ω·cm at the temperature range of 100 to 500° C.

Thus, as shown in FIG. 30, the PM sensor 1 can be obtained in which dead time is short, and the sensor output is greatly changed as the particulate matter adheres.

Furthermore, in the present embodiment, the numerical range of the surface electrical resistivity ρ is defined. This facilitates optimization of electrical characteristics of the conductive sections 2a and 2b. Specifically, in the PM sensor 1 of the present embodiment, the detection electrodes 3a are provided on the principal surface 51 (see FIG. 3) of the detection conductive section 2a. Accordingly, when the PM sensor 1 is used, the electric current I flows near the surface of the detection conductive section 2a. Thus, it can be said that the surface electrical resistivity ρ measured by causing the electric current I to flow near the surface of the plate-shaped substrate 251 (see FIG. 31) is an electrical characteristic measured in conditions similar to actual usage conditions of the PM sensor 1. Thus, by defining the numerical range of the surface electrical resistivity ρ, the electrical characteristic of the detection conductive section 2a in the conditions similar to the actual usage conditions can be defined.

Furthermore, in the present embodiment, ceramic having a perovskite structure is used as the conductive material constituting the conductive sections 2a and 2b. When the ceramic has a molecular formula of ABO₃, A is preferably at least one selected from La, Sr, Ca, and Mg, and B is preferably at least one selected from Ti, Al, Zr, and Y.

Such ceramic has high heat resistance and is less likely to chemically react with a substance contained in the exhaust gas. Accordingly, the ceramic can be appropriately used as the conductive material for the PM sensor 1 exposed to the exhaust gas.

Furthermore, in particular, A in the molecular formula preferably contains Sr as a main component and La as an accessory component, and B is preferably Ti.

As shown in FIG. 29, even when the temperature is changed, the amount of change in surface electrical resistivity ρ of such ceramic is small. This is presumably due to an effect of adding La. When such ceramic is used to form the conductive sections 2a and 2b, an inexpensive measurement circuit can be used for measuring the output of the PM sensor 1. Specifically, as shown in FIG. 29, the surface electrical resistivity ρ of the ceramic (SrTiO₃) containing no La is greatly changed in the range of approximately 1×10⁵ to 1×10¹¹ Ω·cm at the temperature range of 100 to 500° C. Thus, in the conductive sections 2a and 2b formed of the ceramic (SrTiO₃), only a small amount of electric current flows at a temperature of approximately 100° C., and a large amount of electric current flows at a temperature of approximately 500° C. This requires use of an expensive measurement circuit having a broad measurement range for electric current. On the other hand, when the ceramic (Sr₁₋ₓLaxTiO₃) containing La is used, the amount of change in the surface electrical resistivity ρ at the temperature range of 100 to 500° C. can be made small. Thus, the change in electric current flowing through the conductive sections 2a and 2b at the above temperature range can be made small. This enables use of an inexpensive measurement circuit having a narrow measurement range for electric current.

Other than this, the tenth embodiment has a configuration and effects similar to those of the first embodiment.

### Eleventh Embodiment

The present embodiment is an example in which the configuration of the control section 6 is modified. As with the first embodiment, the particulate matter detection apparatus 10 of the present embodiment includes the PM sensor 1 and the control section 6 (see FIG. 5).

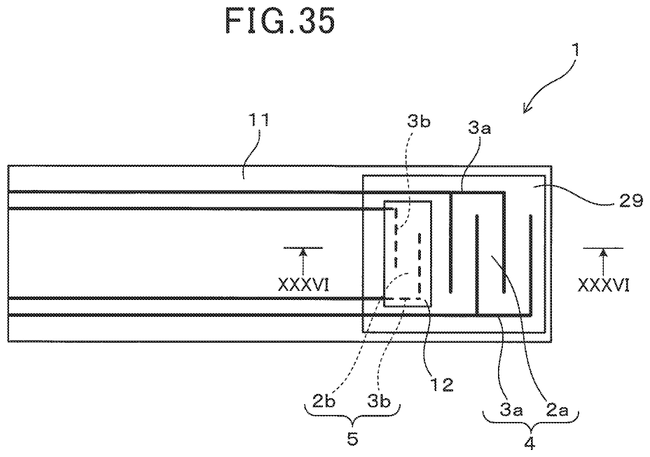

As illustrated in FIG. 35, the PM sensor 1 includes the detection conductive section 2a and the detection electrodes 3a. As with the first embodiment, the detection conductive section 2a is made of a conductive material having a higher electrical resistivity than that of the PM 8, and the deposition surface 20 on which the PM 8 is deposited is provided on a surface of the detection conductive section 2a. The pair of detection electrodes 3a are provided on the deposition surface 20. The detection conductive section 2a and the detection electrodes 3a constitute the PM detection section 4.

The control section 6 is configured to increase the temperature of the detection conductive section 2a and detect the PM 8, while the temperature of the detection conductive section 2a is controlled, so that, in a state in which no PM 8 is deposited, the detection conductive section resistance Rₐ, which is the electrical resistance of the detection conductive section 2a between the pair of detection electrodes 3a, has a predetermined value R_{TH}.

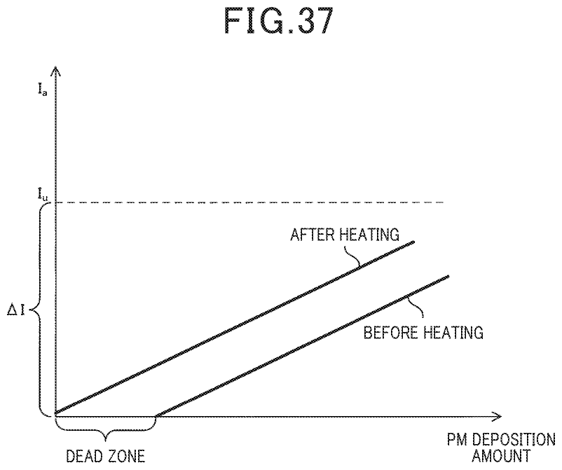

Unless being heated, the conductive material constituting the detection conductive section 2a has high resistance and has a characteristic similar to that of an insulator. Thus, as shown in FIG. 37, before the detection conductive section 2a is heated, the electric current Iₐ does not flow between the detection electrodes 3a until a certain amount of PM 8 is deposited on the deposition surface 20. In the present embodiment, therefore, the PM 8 is detected after the detection conductive section 2a is heated by the heater 111, and the detection conductive section resistance Rₐ is decreased. When the detection conductive section 2a is heated, and the detection conductive section resistance Rₐ is controlled to have an optimum value, as shown in FIG. 37, a small amount of electric current starts flowing between the detection electrodes 3a in a state in which no PM 8 is deposited. Accordingly, even when a small amount of PM 8 is deposited, the electric current Iₐ is changed, and thus the deposition of the PM 8 can be detected.

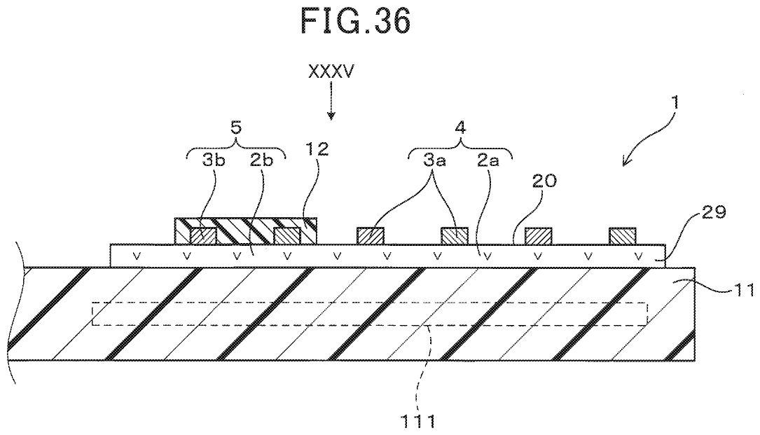

Furthermore, as illustrated in FIGS. 35 and 36, as with the first embodiment, the PM sensor 1 of the present embodiment includes the monitor conductive section 2b and the pair of monitor electrodes 3b. The monitor conductive section 2b and the monitor electrodes 3b constitute the resistance monitor section 5. The monitor conductive section 2b is integrated with the detection conductive section 2a to constitute the single conductive plate section 29. Furthermore, the monitor conductive section 2b is covered with the insulating film 12. Thus, the resistance monitor section 5 is configured such that no PM 8 is deposited on the monitor conductive section 2b. In the present embodiment, the resistance R_{b} of the monitor conductive section 2b is measured, and the temperature of the detection conductive section 2a is controlled by using the measured value of the resistance R_{b} so that the detection conductive section resistance Rₐ has a predetermined value.

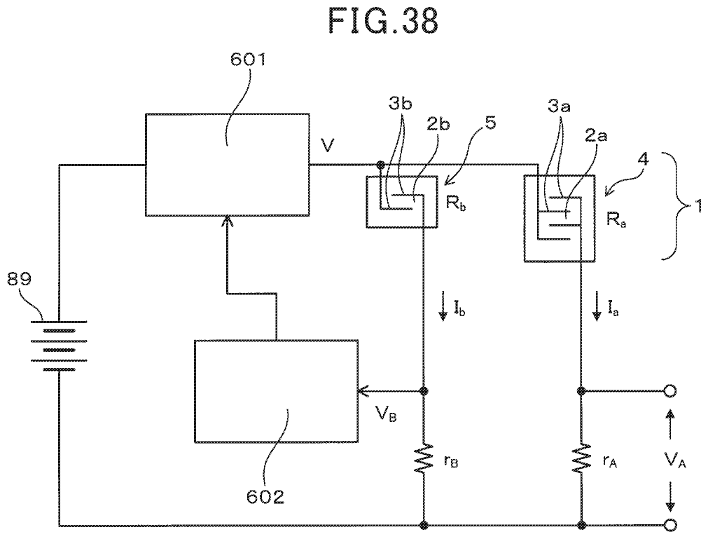

A circuit connected to the PM sensor 1 will be described below with reference to FIG. 38. A boosting circuit 601, a resistance measurement section 602, and shunt resistors r_{A} and r_{B} are connected to the PM sensor 1. The boosting circuit 601 boosts a voltage of a DC power supply 89, and the boosted voltage is applied to the PM sensor 1. When the conductive sections 2a and 2b are heated, the resistances are decreased, and the electric currents Iₐ and I_{b} flow. The resistance measurement section 602 measures a voltage drop V_{B} occurring when the electric current I_{b} that has flowed through the monitor conductive section 2b passes through the shunt resistor r_{B}. The resistance measurement section 602 calculates the electric current I_{b} (=V_{B}/r_{B}) flowing through the monitor conductive section 2b, by using the measured value of the voltage drop V_{B}. Furthermore, the resistance measurement section 602 calculates the resistance R_{b} (=V/I_{b}) of the monitor conductive section 2b from the electric current I_{b} and an output voltage V of the boosting circuit 601. In the present embodiment, the temperature is controlled so that the resistance R_{b} has a predetermined value. Thus, the detection conductive section resistance Rₐ is controlled to have a predetermined value.

Furthermore, as illustrated in FIG. 38, when the electric current Iₐ of the detection conductive section 2a flows through the shunt resistor r_{A}, a voltage drop V_{A} occurs. The control section 6 calculates the electric current Iₐ (=V_{A}/r_{A}) of the detection conductive section 2a by using a measured value of the voltage drop V_{A}. Thus, the amount of PM 8 deposited on the deposition surface 20 is calculated.

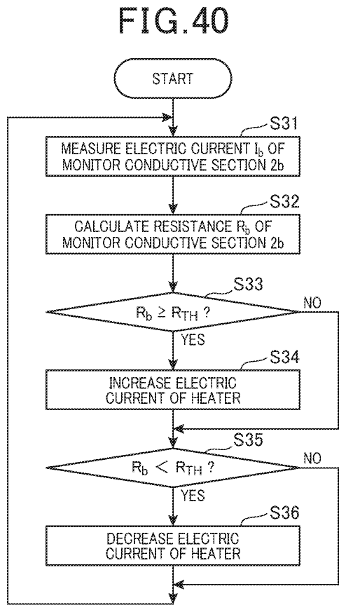

A flow chart for the control section 6 will be described below. As shown in FIG. 40, the control section 6 first performs step S31. In this step, the electric current I_{b} of the monitor conductive section 2b is measured. Subsequently, the control proceeds to step S32. In this step, the resistance R_{b} (=V/I_{b}) of the monitor conductive section 2b is calculated.

Subsequently, the control proceeds to step S33. In this step, it is determined whether the measured resistance R_{b} is higher than a threshold R_{TH}. In this step, if an affirmative determination (Yes) is made (i.e., it is determined that the temperature is low and the resistance R_{b} and the detection conductive section resistance Rₐ are high), the control proceeds to step S34, and if a negative determination (No) is made, the control proceeds to step S35. In step S34, electric current of the heater 111 is increased. Thus, the temperatures of the conductive sections 2a and 2b are increased, and the resistance Rₐ of the conductive section 2a and the resistance R_{b} of the conductive section 2b are decreased.

In step S35, it is determined whether the resistance R_{b} of the monitor conductive section 2b is lower than the threshold R_{TH}. In this step, if an affirmative determination (Yes) is made (i.e., it is determined that the temperature is high and the resistance R_{b} and the detection conductive section resistance Rₐ are low), the control proceeds to step S36, and if a negative determination (No) is made, the control returns to step S31. In step S36, the electric current of the heater 111 is reduced. Thus, the temperatures of the conductive sections 2a and 2b are decreased, and the resistance Rₐ of the conductive section 2a and the resistance R_{b} of the conductive section 2b are increased.

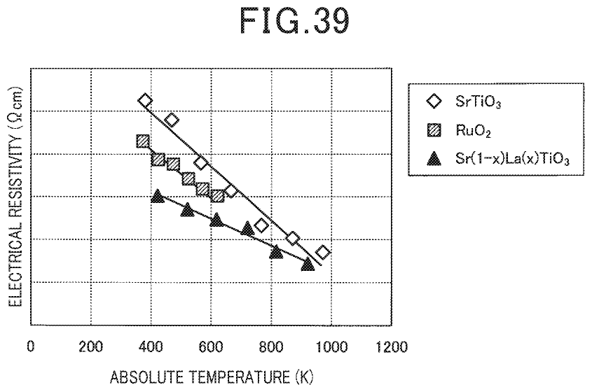

Composition of the conductive material constituting the conductive sections 2a and 2b will be described below. In the present embodiment, Sr₁₋ₓLaxTiO₃ is used as the conductive material. As shown in FIG. 39, the amount of change in resistivity of Sr₁₋ₓLaxTiO₃ according to the temperature is small as compared with SrTiO₃, RuO₂, and the like. Accordingly, if Sr₁₋ₓLaxTiO₃ is used to constitute the conductive sections 2a and 2b, even when the temperature is changed, the resistances Rₐ and R_{b} are less likely to be changed, and this facilitates controlling the resistances Rₐ and R_{b} to be within a predetermined range.

Effects of the present embodiment will be described below. The control section 6 of the present embodiment is configured to increase the temperature of the detection conductive section 2a and detect the PM 8 while the temperature of the detection conductive section 2a is controlled so that the detection conductive section resistance Rₐ has the predetermined value R_{TH}.

Accordingly, the PM 8 can be detected after the detection conductive section resistance Rₐ has reached an optimum value. Thus, the amount of PM 8 can be accurately detected.

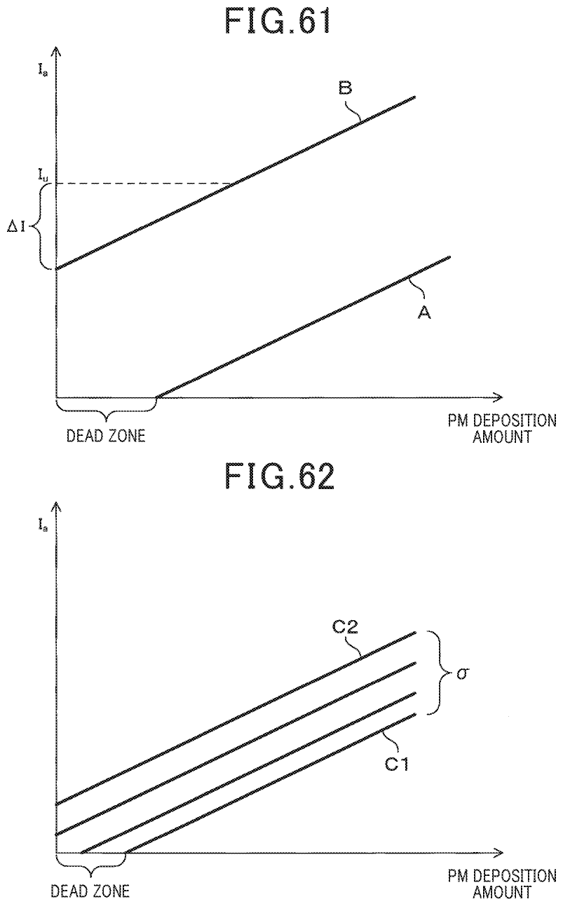

Specifically, if the detection conductive section resistance Rₐ is excessively high, as indicated by straight line A in FIG. 61, the electric current Iₐ is not increased until a certain amount of PM 8 is deposited, and this causes a dead zone. Furthermore, if the detection conductive section resistance Rₐ is excessively low, as indicated by straight line B in FIG. 61, a large amount of electric current Iₐ flows even in a state in which no PM 8 is deposited. The voltage V (see FIG. 38) that can be applied to the detection conductive section 2a is limited, and thus the electric current Iₐ that can flow through the detection conductive section 2a has an upper limit value I_{U}. Accordingly, when a large amount of electric current Iₐ flows in a state in which no PM 8 is deposited, the electric current Iₐ immediately reaches the upper limit value I_{U}, and this narrows a range ΔI in which the PM 8 can be detected.

On the other hand, as shown in FIG. 37, as in the present embodiment, when the detection conductive section 2a having a high resistance value before being heated is used and heated so that the detection conductive section resistance Rₐ is controlled to have the optimum value R_{TH}, a small amount of electric current Iₐ can flow through in a state in which no PM 8 is deposited. Thus, no dead zone is caused, and even when the PM 8 is deposited, the electric current Iₐ does not easily reach the upper limit value I_{U}. This can broaden the range ΔI in which the PM 8 can be detected.

Furthermore, the composition of the conductive material may be adjusted so that the detection conductive section resistance Rₐ has the optimum value R_{TH} in a state in which the detection conductive section 2a has not been heated. In such a case, however, due to variations in resistance value of the conductive material or in temperature of the exhaust gas, as shown in FIG. 62, a dead zone (e.g., corresponding to straight line C1) may occur or a large amount of electric current Iₐ may flow in a state in which no PM 8 is deposited (e.g., corresponding to straight line C2). In the present embodiment, even when, before the detection conductive section 2a is heated, variations occur in the detection conductive section resistance Rₐ or in the temperature of the exhaust gas, the detection conductive section 2a can be heated so that the detection conductive section resistance Rₐ has the optimum resistance value R_{TH}. This enables accurate measurement of the PM 8 and achieves a broad detection range ΔI.

Furthermore, as illustrated in FIGS. 35 and 36, the PM sensor 1 of the present embodiment includes the resistance monitor section 5 constituted by the monitor conductive section 2b and the monitor electrodes 3b. The resistance monitor section 5 is configured such that no PM 8 is deposited on the monitor conductive section 2b. Accordingly, by measuring the resistance R_{b} of the monitor conductive section 2b between the pair of monitor electrodes 3b, it is possible to accurately calculate the resistance (i.e., the detection conductive section resistance Rₐ) of the detection conductive section 2a in a state in which no PM 8 is deposited. Thus, the detection conductive section resistance Rₐ is easily controlled to have a predetermined value.

Furthermore, as illustrated in FIG. 36, the particulate matter detection sensor 1 of the present embodiment includes the heater 111 for burning the PM 8 deposited on the deposition surface 20. When the PM 8 is detected, the particulate matter detection sensor 1 causes the heater 111 to generate a small amount of heat, and the heat is used to heat the detection conductive section 2a. As shown in FIG. 40, the control section 6 is configured to control the temperature of the detection conductive section 2a by controlling the amount of electric current flowing through the heater 111.

As described later, it is possible to use resistance heat of the detection conductive section 2a, without using the heater 111, to heat the detection conductive section 2a. In this case, however, the amount of generated heat is small, and this may prevent the detection conductive section 2a from being heated in a short time. When the heater 111 is used as in the present embodiment, however, the amount of generated heat is large, and thus the detection conductive section 2a can be heated in a short time.

Other than this, the eleventh embodiment has a configuration and effects similar to those of the first embodiment.

In the present embodiment, the detection conductive section resistance Rₐ is controlled to have the single value R_{TH}. However, the present invention is not limited to this. The detection conductive section resistance Rₐ can be controlled to have a value within a predetermined range (R_{TH1} to R_{TH2}). By doing this, the detection conductive section resistance Rₐ can be controlled to be within a certain range, and this facilitates control of the detection conductive section resistance Rₐ.

### Twelfth Embodiment

The present embodiment is an example in which the method of heating the detection conductive section 2a is modified. In the present embodiment, resistance heat generated when the electric current Iₐ flows through the detection conductive section 2a is used to increase the temperature of the detection conductive section 2a. By controlling the voltage V applied between the pair of detection electrodes 3a (see FIGS. 35 and 38), the control section 6 controls the temperature of the detection conductive section 2a and controls the detection conductive section resistance Rₐ.

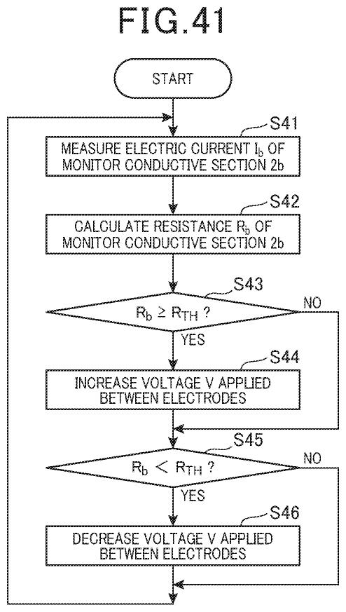

A flow chart for the control section 6 will be described below. As shown in FIG. 41, the control section 6 first performs step S41. In this step, as with the eleventh embodiment, the electric current I_{b} of the monitor conductive section 2b is measured. Subsequently, the control proceeds to step S42. In this step, the resistance R_{b} (=V/I_{b}) of the monitor conductive section 2b is calculated.

Next, the control proceeds to step S43. In this step, it is determined whether the calculated resistance R_{b} is a threshold R_{TH} or more. In this step, if an affirmative determination (Yes) is made (i.e., it is determined that the temperature is low and the resistance R_{b} and the detection conductive section resistance Rₐ are high), the control proceeds to step S44, and if a negative determination (No) is made, the control proceeds to step S45. In step S44, the voltage V applied between the pair of detection electrodes 3a and between the pair of monitor electrodes 3b, i.e., the output voltage V of the boosting circuit 601 (see FIG. 38) is increased. Thus, the amount of heat generated by the detection conductive section 2a is increased, and the detection conductive section resistance Rₐ is decreased.

In step S45, it is determined whether the detection conductive section resistance Rₐ is less than the threshold R_{TH}. In this step, if an affirmative determination (Yes) is made (i.e., it is determined that the temperature is high and the resistance R_{b} and the detection conductive section resistance Rₐ are low), the control proceeds to step S46, and if a negative determination (No) is made, the control proceeds to step S41. In step S46, the voltage V applied between the pair of detection electrodes 3a and between the pair of monitor electrodes 3b is decreased. Thus, the amount of heat generated by the detection conductive section 2a is decreased, and the detection conductive section resistance Rₐ is increased.

Effects of the present embodiment will be described. In the present embodiment, the resistance heat of the detection conductive section 2a is used to increase the temperature of the detection conductive section 2a. Furthermore, the control section 6 controls the temperature of the detection conductive section 2a by controlling the voltage V applied between the pair of detection electrodes 3a.

By doing this, the detection conductive section 2a can be uniformly heated as compared with the case where the heater 111 (see FIG. 36) is used. Furthermore, this facilitates fine adjustment of the temperature of the detection conductive section 2a.

Other than this, the twelfth embodiment has a configuration and effects similar to those of the eleventh embodiment.

### Thirteenth Embodiment

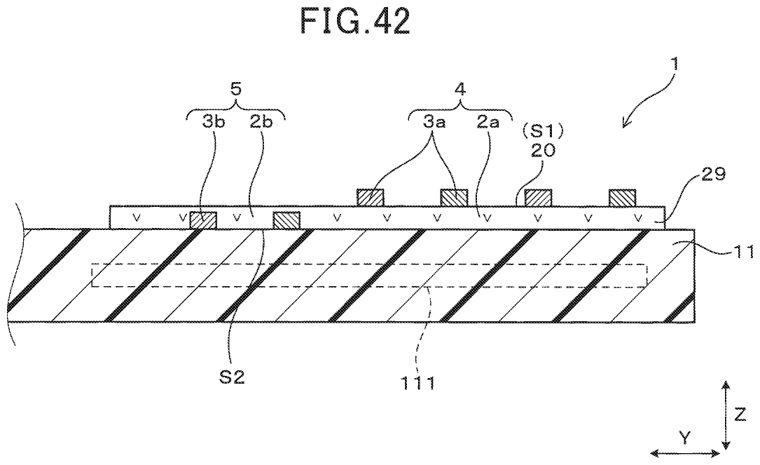

The present embodiment is an example in which the structure of the PM sensor 1 is modified. As illustrated in FIG. 42, in the present embodiment, the detection conductive section 2a is integrated with the monitor conductive section 2b to constitute the single conductive plate section 29. The conductive plate section 29 is supported by the substrate section 11. The monitor conductive section 2b is a portion of the conductive plate section 29 on the side closer to the substrate section 11 in the plate thickness direction (i.e., the Z direction), and the detection conductive section 2a is a portion of the conductive plate section 29 opposite to the monitor conductive section 2b. Furthermore, the monitor electrodes 3b are provided in the principal surface S2 of the conductive plate section 29 on the side closer to the substrate section 11, and the deposition surface 20 is provided on the principal surface S1 of the conductive plate section 29 opposite to the principal surface S2.

The above configuration enables the substrate section 11 to prevent the PM 8 from adhering to the surface S2 of the monitor conductive section 2b. Accordingly, unlike the eleventh embodiment, the insulating film 12 (see FIG. 36) does not need to be formed, and thus the configuration of the PM sensor 1 can be simplified.

Other than this, the thirteenth embodiment has a configuration and effects similar to those of the first embodiment.

### Fourteenth Embodiment

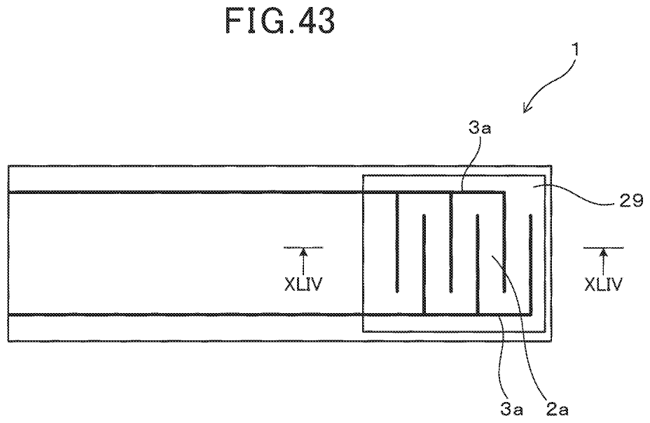

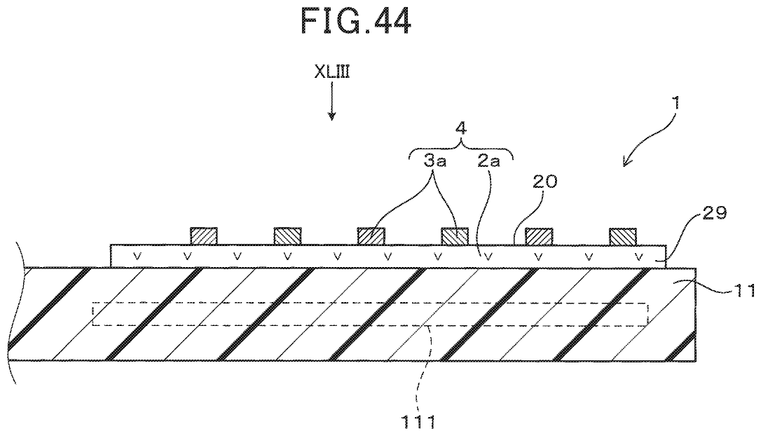

The present embodiment is an example in which the configuration of the PM sensor 1 and the method of controlling the detection conductive section resistance Rₐ are modified. As illustrated in FIGS. 43 and 44, the PM sensor 1 of the present embodiment includes only the detection conductive section 2a and the detection electrodes 3a, and does not include the monitor conductive section 2b or the monitor electrode 3b. The heater 111 for burning the PM 8 is provided in the substrate section 11 supporting the detection conductive section 2a.

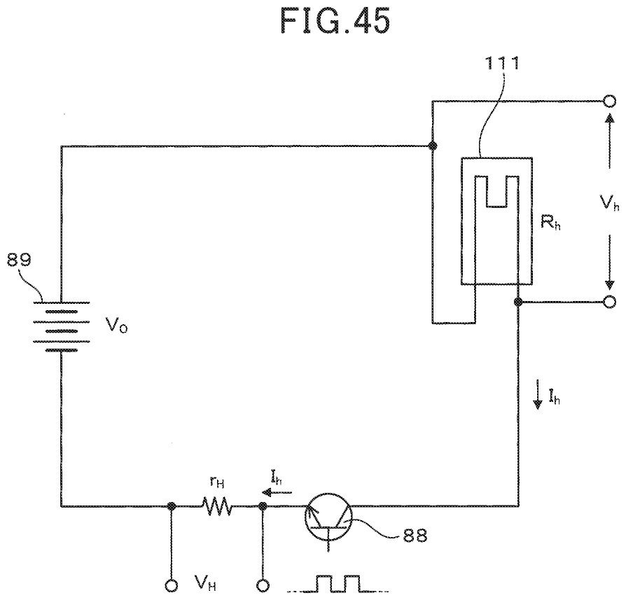

In the present embodiment, by controlling a resistance Rₕ of the heater 111, the temperature is controlled so that the detection conductive section resistance Rₐ is within a predetermined range. As illustrated in FIG. 45, the DC power supply 89, a switching element 88, and a shunt resistor r_{H} are connected to the heater 111. The control section 6 switches the switching element 88 on and off to cause the heater 111 to generate heat. When an electric current Iₕ flows through the heater 111, a voltage drop V_{H} occurs in the shunt resistor r_{H}. The control section 6 measures the heater current Iₕ (=V_{H}/r_{H}) by using a measured value of the voltage drop V_{H}.

Furthermore, the control section 6 also measures an inter-terminal voltage Vₕ of the heater 111. The control section 6 calculates the heater resistance Rₕ (=Vₕ/Iₕ) by using the measured value of the inter-terminal voltage Vₕ.

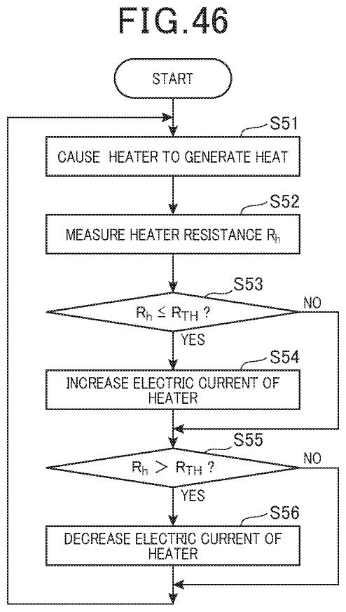

A flow chart for the control section 6 will be described below. As shown in FIG. 46, the control section 6 first performs step S51. In this step, the control section 6 causes the heater 111 to generate heat. Subsequently, the control proceeds to step S52. In this step, the heater resistance Rₕ (=Vₕ/Iₕ) is measured.

Subsequently, the control proceeds to step S53. In this step, it is determined whether the heater resistance Rₕ is a predetermined threshold R_{TH} or less (i.e., whether the temperature of the heater 111 is excessively low, and the detection conductive section resistance Rₐ is excessively high). In this step, if an affirmative determination (Yes) is made (i.e., it is determined that the detection conductive section resistance Rₐ is excessively high), the control proceeds to step S54, and if a negative determination (No) is made, the control proceeds to step S55. In step S54, the electric current Iₕ flowing through the heater 111 is increased. Thus, the temperature of the detection conductive section 2a is increased, and the detection conductive section resistance Rₐ is decreased.

In step S55, it is determined whether the heater resistance Rₕ has exceeded the threshold (i.e., whether the temperature of the heater 111 is excessively high, and the detection conductive section resistance Rₐ is excessively low). In this step, if an affirmative determination (Yes) is made (i.e., it is determined that the detection conductive section resistance Rₐ is excessively low), the control proceeds to step S56, and if a negative determination (No) is made, the control returns to step S51. In step S56, the electric current Iₕ of the heater 111 is reduced. Thus, the temperature of the detection conductive section 2a is decreased, and the detection conductive section resistance Rₐ is increased.

Effects of the present embodiment will be described. In the present embodiment, the temperature of the detection conductive section 2a is controlled by controlling the resistance Rₕ of the heater 111. Accordingly, unlike the eleventh embodiment and the like, the PM sensor 1 does not need to include the monitor conductive section 2b or the monitor electrode 3b. Thus, the configuration of the PM sensor 1 can be simplified.

Other than this, the fourteenth embodiment has a configuration and effects similar to those of the eleventh embodiment.

### Fifteenth Embodiment

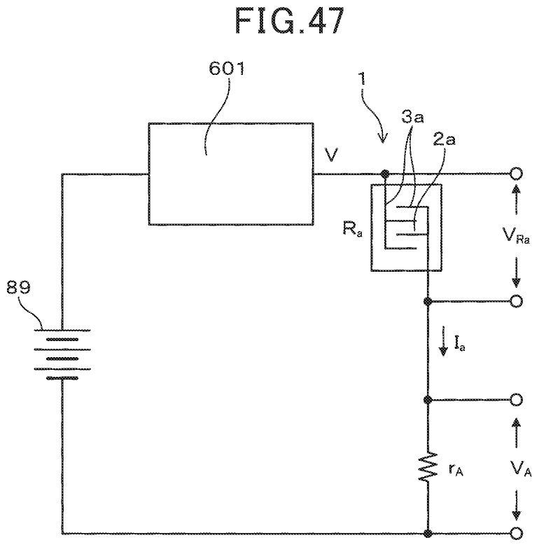

The present embodiment is an example in which the method of controlling the detection conductive section resistance Rₐ is modified. As illustrated in FIG. 47, as with the fourteenth embodiment, the PM sensor 1 of the present embodiment does not include the monitor conductive section 2b or the monitor electrode 3b. The PM sensor 1 of the present embodiment is configured to measure the detection conductive section resistance Rₐ. Specifically, as illustrated in FIG. 47, the PM sensor 1 of the present embodiment is configured to measure a voltage V_{Ra} between the pair of detection electrodes 3a. As with the eleventh embodiment, the control section 6 measures the electric current Iₐ (=V_{A}/r_{A}) that has flowed through the detection conductive section 2a, by measuring the voltage drop V_{A} of the shunt resistor r_{A} connected to the detection electrodes 3a. Then, the control section 6 calculates the detection conductive section resistance Rₐ (=V_{Ra}/Iₐ) by using the measured value of the electric current Iₐ and the voltage VRₐ. Then, the control section 6 causes the heater 111 (see FIG. 44) to generate heat, and controls the temperature of the detection conductive section 2a so that the detection conductive section resistance Rₐ is within a predetermined range.

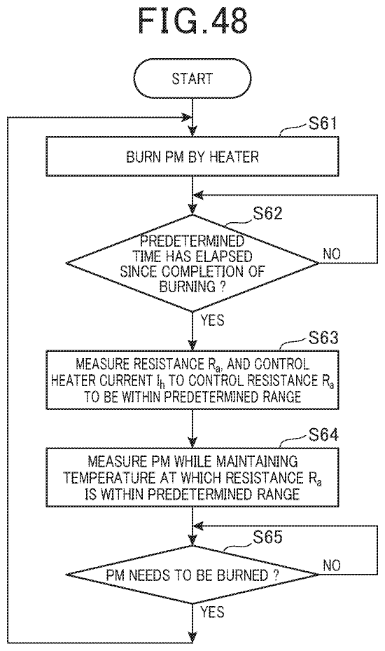

A flow chart for the control section 6 will be described below. As shown in FIG. 48, the control section 6 first performs step S61. In this step, the PM 8 is burned by the heater 111. Subsequently, the control proceeds to step S62. In this step, it is determined whether a predetermined time has elapsed since completion of the burning (i.e., whether the detection conductive section 2a has been sufficiently cooled down). If an affirmative determination (Yes) is made in this step, the control proceeds to step S63.

In step S63, the detection conductive section resistance Rₐ is measured. Then, by controlling the heater current Iₕ, the temperature is controlled so that the detection conductive section resistance Rₐ is within a predetermined range. Subsequently, the control proceeds to step S64. In this step, the PM 8 is detected while the temperature at which the detection conductive section resistance Rₐ is within the predetermined range is maintained by causing the heater current Iₕ determined in step S63 to flow. Subsequently, the control proceeds to step S65. In this step, it is determined whether the PM 8 needs to be burned. In this step, if an affirmative determination (Yes) is made, the control returns to step S61, and if a negative determination (No) is made, the control returns to step S64.

Effects of the present embodiment will be described. In the present embodiment, as shown in FIG. 48, after the PM 8 is burned, i.e., in a state in which no PM 8 is deposited on the deposition surface 20, the detection conductive section resistance Rₐ (the resistance between the pair of detection electrodes 3a) is measured. Then, the PM 8 is detected while the temperature at which the detection conductive section resistance Rₐ is within the predetermined range is maintained.

By doing this, the detection conductive section resistance Rₐ can be directly measured in a state in which no PM 8 is deposited. Accordingly, unlike Embodiment 11 and the like, the PM sensor 1 does not need to include the monitor conductive section 2b or the monitor electrode 3b. Thus, the configuration of the PM sensor 1 can be simplified.

Other than this, the fifteenth embodiment has a configuration and effects similar to those of the eleventh embodiment.

### Sixteenth Embodiment

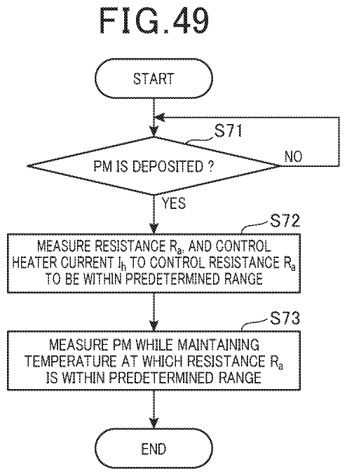

The present embodiment is an example in which the control method by the control section 6 is modified. As with the fifteenth embodiment, the PM sensor 1 of the present embodiment does not include the monitor conductive section 2b or the monitor electrode 3b. As with the fifteenth embodiment, the PM sensor 1 of the present embodiment is configured to directly measure the resistance Rₐ of the detection conductive section 2a. As shown in FIG. 49, the control section 6 of the present embodiment first performs step S71. In this step, by using information on an operating state of the engine 71 (see FIG. 5) emitting exhaust gas, it is determined whether the PM 8 is deposited on the deposition surface 20. For example, when fuel cut has been performed with respect to the engine 71, the concentration of the PM 8 in the exhaust gas is low, and thus it is determined that no PM 8 is deposited on the deposition surface 20 (No). When no fuel cut has been performed with respect to the engine 71, the concentration of the PM 8 is high, and thus it is determined that the PM 8 is deposited on the deposition surface 20 (Yes).

When a negative determination (No) is made in step S71 (i.e., it is determined that no PM 8 is deposited), the control proceeds to step S72, and the detection conductive section resistance Rₐ is measured. Then, by controlling the heater current Iₕ, the detection conductive section resistance Rₐ is controlled to be within a predetermined range.

Next, the control proceeds to step S73. In this step, the PM 8 is detected while the temperature at which the detection conductive section resistance Rₐ is within the predetermined range is maintained by causing the heater current I_{b} determined in step S72 to flow.

Effects of the present embodiment will be described. In the present embodiment, by using the information on the operating state of the engine 71, it is determined whether the PM 8 is deposited on the deposition surface 20 (step S71). Then, when it is determined that no PM 8 is deposited on the deposition surface 20, the detection conductive section resistance Rₐ (i.e., the resistance between the pair of detection electrodes 3a) is measured, and the temperature is controlled so that the measured value of the detection conductive section resistance Rₐ is within the predetermined range.

By doing this, the detection conductive section resistance Rₐ can be directly measured in a state in which no PM 8 is deposited on the deposition surface 20. Accordingly, unlike the eleventh embodiment and the like, the PM sensor 1 does not need to include the monitor conductive section 2b or the monitor electrode 3b. Thus, the configuration of the PM sensor 1 can be simplified.

Other than this, the sixth embodiment has a configuration and effects similar to those of the eleventh embodiment.

In the present embodiment, it is determined whether the PM 8 is deposited on the deposition surface 20 by determining whether fuel cut has been performed with respect to the engine 71. However, the present invention is not limited to this. For example, it can be determined whether the PM 8 is deposited on the deposition surface 20 by determining whether EGR (Exhaust Gas Recirculation) has been performed. Specifically, when EGR has been performed, a large amount of PM 8 is generated, and thus it is determined that the PM 8 is deposited on the deposition surface 20. When no EGR has been performed, a small amount of PM 8 is generated, and thus it is determined that no PM 8 is deposited on the deposition surface 20.

Other than this, the sixteenth embodiment has a configuration and effects similar to those of the eleventh embodiment.

### Seventeenth Embodiment

The present embodiment is an example in which the configuration of the PM sensor 1 is modified. As illustrated in FIG. 50, as with the sixth embodiment, the PM sensor 1 of the present embodiment includes the detection conductive section 2a and the monitor conductive section 2b. The conductive sections 2a and 2b are mounted on the substrate section 11. The detection conductive section 2a is provided with the detection electrodes 3a, and the monitor conductive section 2b is provided with the monitor electrodes 3b. A surface of the monitor conductive section 2b is covered with a gas permeable insulating film 121. The gas permeable insulating film 121 is a film that prevents the PM 8 from passing through and allows a gas component contained in the exhaust gas to pass through.

More specifically, in the present embodiment, porous ceramic is used for the gas permeable insulating film 121. The porous ceramic has a plurality of pores inside, and the pores are connected to each other to form communication holes. The communication holes extend from an exposed surface S3 of the gas permeable insulating film 121 to a surface S1 opposite to the exposed surface S3. The gas permeable insulating film 121 is configured such that the gas component can reach the monitor conductive section 2b through the communication holes.

Thus, when the monitor conductive section 2b is covered with the gas permeable insulating film 121, accuracy of detection of the PM 8 can be further improved. Specifically, when the conductive material constituting the detection conductive section 2a is exposed to the gas component, such as SOx contained in the exhaust gas, transfer of electrons occurs between the conductive material and the gas component, and this may cause a change in electrical conductivity. Accordingly, when the monitor conductive section 2b is covered with the insulating film 12 having no gas permeability, the electrical resistance (i.e., the detection conductive section resistance Rₐ) of the detection conductive section 2a which is exposed to the gas component may be deviated from the electrical resistance (i.e., the compensation resistance R_{b}) of the monitor conductive section 2_{b} which is not exposed to the gas component. This may prevent accurate compensation for the detection conductive section resistance Rₐ and cause a decrease in accuracy of detection of the PM 8. As in the present embodiment, when the monitor conductive section 2b is covered with the gas permeable insulating film 121, however, the monitor conductive section 2b is also exposed to the gas component, and thus the difference between the detection conductive section resistance Rₐ and the compensation resistance R_{b} can be made small. This facilitates compensation for the detection conductive section resistance Rₐ, and thus accuracy of detection of the PM 8 can be further improved.

Furthermore, when a porous material is used for the gas permeable insulating film 121, thermal capacity of the gas permeable insulating film 121 can be made small. Thus, heat is more likely to transfer from the exhaust gas to the monitor conductive section 2b. Accordingly, the difference in temperature between the detection conductive section 2a and the monitor conductive section 2b can be made small, and this facilitates accurate compensation for the change in the detection conductive section resistance Rₐ according to the temperature. Thus, accuracy of detection of the PM 8 can be further improved.

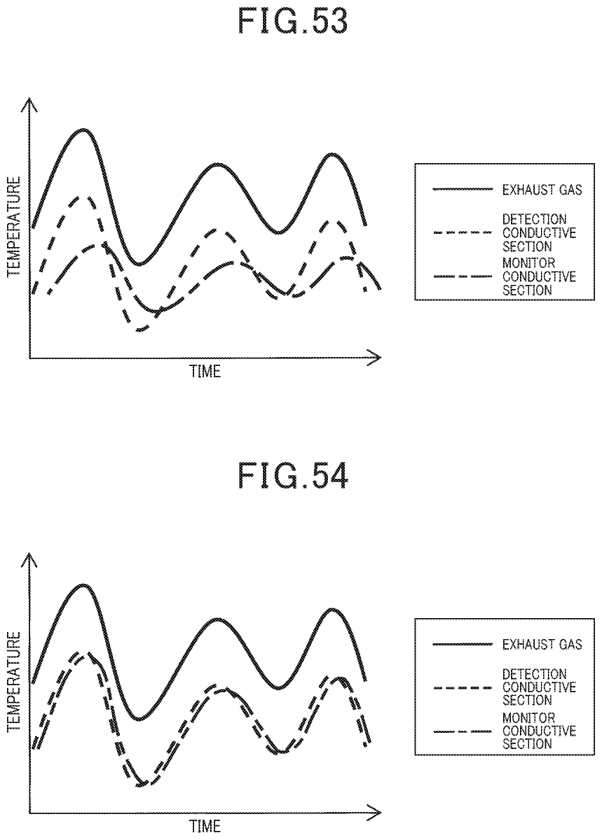

Specifically, when the monitor conductive section 2b is covered with the insulating film 12 that is thick and not porous, the temperature may to some extent be less likely to transfer from the exhaust gas to the monitor conductive section 2b. Thus, as shown in FIG. 53, when the temperature of the exhaust gas is changed, the temperature of the monitor conductive section 2b may be changed with a slight delay. Furthermore, the amount of change in temperature of the monitor conductive section 2b may be smaller than the amount of change in temperature of the detection conductive section 2a. On the other hand, when the monitor conductive section 2b is covered with the gas permeable insulating film 121 made of a porous material, as shown in FIG. 54, for the change in temperature of the monitor conductive section 2b, responsiveness to the change in temperature of the exhaust gas can be improved. Furthermore, the amount of change in temperature becomes large. Thus, the difference between the temperature of the detection conductive section 2a and the temperature of the monitor conductive section 2b becomes small, and this facilitates accurate compensation for the detection conductive section resistance Rₐ. Thus, accuracy of detection of the PM 8 can be improved.

As described above, the gas permeable insulating film 121 is a film that prevents the PM 8 from passing through. The “prevention” here does not mean complete blockage of passage of the PM 8 through the gas permeable insulating film 121. For example, the PM 8 may pass through the gas permeable insulating film 121 to such an extent that an output of the resistance monitor section 5 is hardly changed. For example, when the PM 8 has a small particle size, a small amount of PM 8 may reach the monitor conductive section 2b through the communication holes. More specifically, the present embodiment uses the gas permeable insulating film 121 capable of preventing the PM 8 from reaching the monitor conductive section 2b during a time period in which the PM sensor 1 detects the PM 8, i.e., from the end of the process of causing the heater 111 (see FIG. 50) to generate heat to burn the PM 8 on the deposition surface 20 until next heat generation by the heater 111.

As described above, it is preferable to use porous ceramic for the gas permeable insulating film 121. More specifically, it is preferable to use porous ceramic such as alumina (e.g., a alumina, θ alumina), spinel, silica, or titania. Furthermore, the porous ceramic preferably has a porosity of 10 to 75%. If the porous ceramic has a porosity of less than 10%, permeability of the gas component is more likely to be decreased. If the porous ceramic has a porosity of more than 75%, strength of the gas permeable insulating film 121 is more likely to be decreased. A more preferable porosity is in a range of 45 to 60%.

Furthermore, the gas permeable insulating film 121 preferably has a thickness of 10 μm or more. A further preferable thickness of the gas permeable insulating film 121 is in a range of 30 to 2000 μm. If the gas permeable insulating film 121 has a thickness of less than 30 μm, strength of the gas permeable insulating film 121 may be decreased. If the gas permeable insulating film 121 has a thickness of more than 2000 μm, the gas component is less likely to pass through the gas permeable insulating film 121.

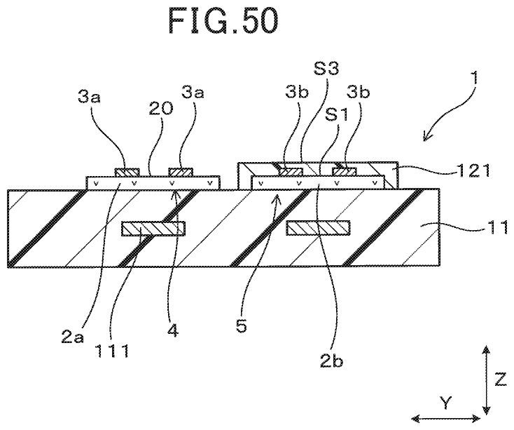

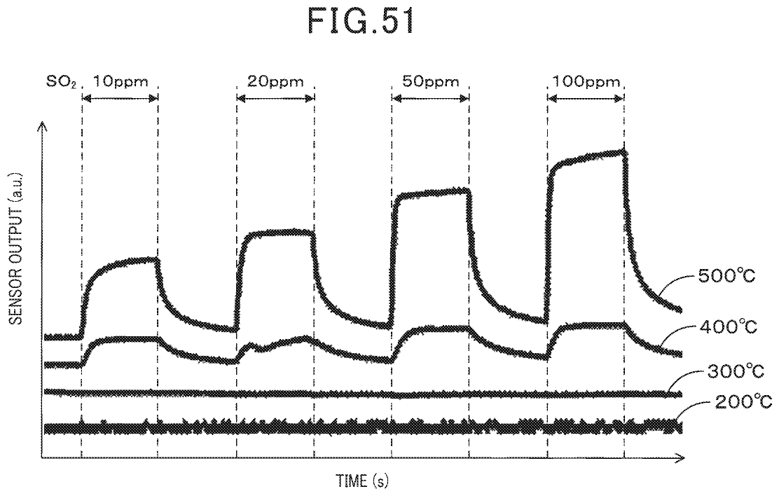

An experiment for confirming the effects of the present embodiment was conducted. First, the PM sensor 1 with the structure illustrated in FIG. 50 was prepared in which the monitor conductive section 2b and the monitor electrodes 3b were covered with the insulating film 12 having no gas permeability. Then, gas containing SO₂ and no PM 8 was blown onto the PM sensor 1, and the difference between an output of the particulate matter detection section 4 and an output of the resistance monitor section 5 (i.e., a sensor output) was measured. Concentrations of SO₂ were set to 10 ppm, 20 ppm, 50 ppm, and 100 ppm. Alumina or the like mentioned above was used for the insulating film 12. FIG. 51 shows a result of the measurement.

FIG. 51 shows that when the insulating film 12 having no gas permeability is used, if the exhaust gas contains SO₂, the sensor output is greatly changed. This is presumably because when the exhaust gas contains SO₂, the electrical resistance Rₐ of the detection conductive section 2a becomes small, and a large amount of electric current flows through the detection conductive section 2a (i.e., the output of the particulate matter detection section 4 becomes large), but no SO₂ reaches the monitor conductive section 2b, and a large amount of electric current is less likely to flow through the monitor conductive section 2b.

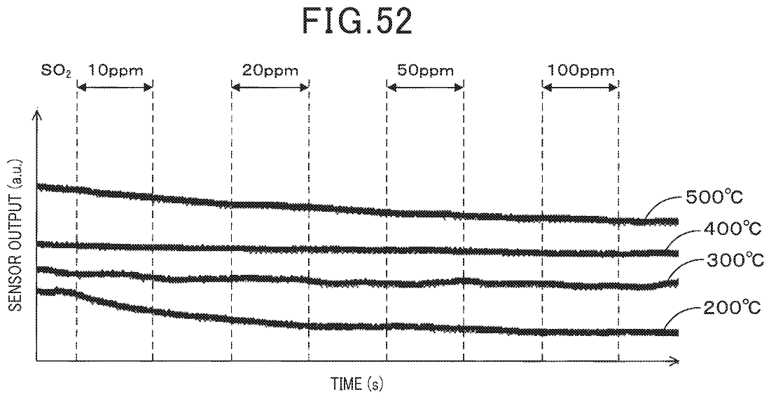

Next, the PM sensor 1 with the structure illustrated in FIG. 50 was prepared in which the monitor conductive section 2b was covered with the gas permeable insulating film 121. Alumina or the like mentioned above was used for the gas permeable insulating film 121. Then, an experiment similar to the experiment mentioned above was conducted. FIG. 52 shows the result of the experiment.

FIG. 52 shows that when the gas permeable insulating film 121 is used, even if the exhaust gas contains SO₂, the sensor output is not greatly changed. This is presumably because when the exhaust gas contains SO₂, the detection conductive section 2a is exposed to SO₂, and the monitor conductive section 2b is also exposed to SO₂ that has passed through the gas permeable insulating film 121, and thus the electrical resistance Rₐ of the conductive section 2ₐ becomes almost the same as the electrical resistances R_{b} of the conductive section 2_{b}. This shows that when the gas permeable insulating film 121 is used, the amount of PM 8 can be accurately measured without being greatly influenced by the gas component such as SO₂.

In the present embodiment, the porous material having the communication holes is used for the gas permeable insulating film 121. However, the present invention is not limited to this. For example, a solid electrolyte that ionizes the gas component and allows the gas component to pass through may be used for the gas permeable insulating film 121. In such a case, the gas permeable insulating film 121 does not need to be porous, and may be a dense film. By doing this, it is possible to reliably prevent the PM 8 from reaching the monitor conductive section 2b.

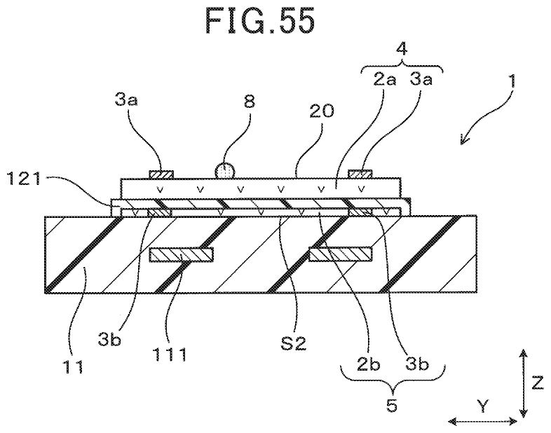

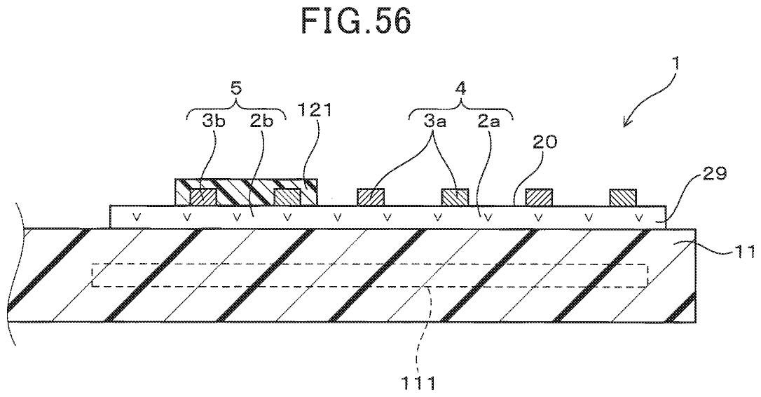

In the present embodiment, the PM sensor 1 with the structure illustrated in FIG. 50 is used. However, the present invention is not limited to this. Specifically, for example, as illustrated in FIG. 55, the PM sensor 1 may be configured such that the monitor conductive section 2b and the monitor electrodes 3b are covered with the gas permeable insulating film 121, and the detection conductive section 2a are provided on the gas permeable insulating film 121. Alternatively, as illustrated in FIG. 56, the PM sensor 1 may be configured such that the monitor conductive section 2b is integrated with the detection conductive section 2a, and the monitor conductive section 2b and the monitor electrodes 3b are covered with the gas permeable insulating film 121.

Other than this, the seventh embodiment has a configuration and effects similar to those of the first embodiment.

The present invention is not limited to the above embodiments, and can be applied to various embodiments without departing from the scope of the present invention.

The present disclosure has been described on the basis of the embodiments, but it is understood that the present disclosure is not limited to the embodiments or the structures. The present disclosure includes various modified examples and modifications within an equivalent range. In addition, a category or range of thought of the present disclosure includes various combinations or forms and other combinations or forms including only one element, one or more elements, or one or less elements of those.

1. A particulate matter detection sensor for detecting an amount of particulate matter contained in exhaust gas, the particulate matter detection sensor comprising:
a particulate matter detection section; and
a resistance monitor section, wherein the particulate matter detection section includes a detection conductive section and a pair of detection electrodes,
the detection conductive section is made of a conductive material having a higher electrical resistivity than that of the particulate matter and has a surface on which a deposition surface is provided, the particulate matter being deposited on the deposition surface,
the pair of detection electrodes are provided to the detection conductive section and face each other across the deposition surface,
the particulate matter detection section is configured such that an electrical resistance between the pair of detection electrodes is changed according to the amount of the particulate matter deposited on the deposition surface,
the resistance monitor section includes a monitor conductive section and a pair of monitor electrodes,
the monitor conductive section is made of the conductive material and is arranged at a position adjacent to the detection conductive section,
the pair of monitor electrodes are provided to the monitor conductive section, and
the resistance monitor section is configured such that no particulate matter is deposited on the monitor conductive section between the pair of monitor electrodes.

2. The particulate matter detection sensor according to claim 1, wherein
the detection conductive section is integrated with the monitor conductive section to constitute a single conductive plate section,
the conductive plate section is supported by a substrate section,
the monitor conductive section is a portion of the conductive plate section on a side closer to the substrate section in a plate thickness direction of the conductive plate section,
the detection conductive section is a portion of the conductive plate section on a side opposite to the monitor conductive section,
the monitor electrodes are provided to a principal surface of the conductive plate section, the principal surface being in contact with the substrate section, and
the deposition surface is provided to a principal surface of the conductive plate section, the principal surface being opposite to the principal surface.

3. The particulate matter detection sensor according to claim 2, wherein
in a state in which the deposition surface is covered with the particulate matter, an interval between the monitor electrode and the detection electrode in the plate thickness direction is determined so that a ratio I_{b}/I_{S} of an electric current I_{b} and an electric current I_{S} is 0.02 or less, the electric current I_{b} flowing between the pair of monitor electrodes, the electric current I_{S} flowing between the pair of detection electrodes.

4. The particulate matter detection sensor according to claim 1, wherein
the detection conductive section is separated from the monitor conductive section,
the detection conductive section and the monitor conductive section each have a plate shape and are supported by the substrate section,
the monitor electrodes are provided to a principal surface of the monitor conductive section, the principal surface being opposite to a principal surface of the monitor conductive section in contact with the substrate section, and
surfaces of the monitor conductive section and the monitor electrodes are covered with an insulating film.

5. The particulate matter detection sensor according to claim 1, wherein
a surface of the monitor conductive section is covered with a gas permeable insulating film, and
the gas permeable insulating film prevents the particulate matter from passing through and allows a gas component contained in the exhaust gas to pass through.

6. The particulate matter detection sensor according to claim 5, wherein
the gas permeable insulating film is made of a porous material having a plurality of communication holes through which the gas component passes.

7. The particulate matter detection sensor according to claim 5, wherein
the gas permeable insulating film is made of a solid electrolyte that ionizes the gas component and allows the gas component to path through.

8. The particulate matter detection sensor according to claim 2, wherein
a heater is provided in the substrate section, and
the heater burns the particulate matter deposited on the deposition surface.

9. The particulate matter detection sensor according to claim 1, wherein
the detection conductive section is integrated with the monitor conductive section to constitute a single conductive plate section,
a heater is provided in the conductive plate section, and
the heater burns the particulate matter deposited on the deposition surface.

10. The particulate matter detection sensor according to claim 1, wherein
the conductive material is used to form the detection conductive section and the monitor conductive section, and
when a sample including a plate-shaped substrate and a pair of measurement electrodes is prepared, and an electrical resistance R between the pair of measurement electrodes is measured to calculate a surface electrical resistivity ρ expressed by the following equation, the surface electrical resistivity ρ is in a range of 1.0×10⁷ to 1.0×10¹⁰ Ω·cm at a temperature range of 100 to 500° C., the plate-shaped substrate being made of the conductive material and having a thickness T of 1.4 mm, the pair of measurement electrodes being provided to a main surface of the plate-shaped substrate, the pair of measurement electrodes having a length of L and being provided at an interval of D.
ρ=R×L×T/D

11. The particulate matter detection sensor according to claim 1, wherein
the conductive material is ceramic having a molecular formula of ABO₃ and having a perovskite structure, where A is at least one selected from La, Sr, Ca, and Mg, and B is at least one selected from Ti, Al, Zr, and Y.

12. The particulate matter detection sensor according to claim 11, wherein
A contains Sr as a main component and La as an accessory component, and B is Ti.

13. A particulate matter detection apparatus comprising:
the particulate matter detection sensor according to claim 1; and
a control section connected to the particulate matter detection sensor, wherein
the control section includes a main measurement section, a compensation measurement section, and a deposition amount calculation section,
the main measurement section measures a particulate matter detection resistance which is an electrical resistance between the pair of detection electrodes,
the compensation measurement section measures a compensation resistance which is an electrical resistance between the pair of monitor electrodes, and
the deposition amount calculation section compensates for a change, according to a temperature, in electrical resistance of the detection conductive section between the pair of detection electrodes by using a measured value of the compensation resistance, and calculates an amount of the particulate matter deposited on the deposition surface.

14. The particulate matter detection apparatus according to claim 13, wherein
an interval Wₐ between the pair of detection electrodes is equal to an interval W_{b} between the pair of monitor electrodes.

15. The particulate matter detection apparatus according to claim 13, wherein
an interval Wₐ between the pair of detection electrodes differs from an interval W_{b} between the pair of monitor electrodes, and
the deposition amount calculation section is configured to calculate the amount of the deposited particulate matter by using a value R_{b}W/W_{b} obtained by multiplying a measured value of the compensation resistance R_{b} by a ratio Wₐ/W_{b} of the interval Wₐ between the pair of detection electrodes to the interval W_{b} between the pair of monitor electrodes.

16. The particulate matter detection apparatus according to claim 13, wherein
the control section includes a temperature calculation section that calculates a temperature of the detection conductive section by using the measured value of the compensation resistance.

17. The particulate matter detection apparatus according to claim 16, wherein
the control section includes a deposition amount correction section that corrects a change in resistivity of the particulate matter according to a temperature by using a calculated value of the temperature and thereby corrects the amount of the deposited particulate matter calculated by the deposition amount calculation section.

18. A particulate matter detection apparatus comprising:
a particulate matter detection sensor for detecting an amount of particulate matter contained in exhaust gas; and
a control section connected to the particulate matter detection sensor, wherein
the particulate matter detection sensor includes a detection conductive section and a pair of detection electrodes,
the detection conductive section is made of a conductive material having a higher electrical resistivity than that of the particulate matter and has a surface on which a deposition surface is provided, the particulate matter being deposited on the deposition surface,
the pair of detection electrodes are provided to the detection conductive section and face each other across the deposition surface,
the particulate matter detection sensor is configured such that an electrical resistance between the pair of detection electrodes is changed according to an amount of particulate matter deposited on the deposition surface, and
the control section is configured to increase a temperature of the detection conductive section and detect the particulate matter while the temperature of the detection conductive section is controlled so that a detection conductive section resistance is within a predetermined range in a state in which no particulate matter is deposited, the detection conductive section resistance being an electrical resistance of the detection conductive section between the pair of detection electrodes.

19. The particulate matter detection apparatus according to claim 18, wherein
the control section is configured to measure an electrical resistance between the pair of detection electrodes in a state in which no particulate matter is deposited on the deposition surface and detect the particulate matter while maintaining a temperature at which a measured value of the electrical resistance is within the range.

20. The particulate matter detection apparatus according to claim 19, wherein
the control section is configured to determine whether the particulate matter is deposited on the deposition surface by using information on an operating state of an engine that emits exhaust gas, and measure the electrical resistance between the pair of detection electrodes when the control section determines that no particulate matter is deposited on the deposition surface.

21. The particulate matter detection apparatus according to claim 18, wherein:
the particulate matter detection sensor further includes a monitor conductive section and a pair of monitor electrodes,
the monitor conductive section is made of the conductive material and is arranged at a position adjacent to the detection conductive section,
the pair of monitor electrodes are provided to the monitor conductive section,
the particulate matter detection sensor is configured such that no particulate matter is deposited on the monitor conductive section between the pair of monitor electrodes, and
the control section is configured to measure a resistance of the monitor conductive section between the pair of monitor electrodes and control the temperature of the detection conductive section by using a measured value of the resistance so that the detection conductive section resistance is within the range.

22. The particulate matter detection apparatus according to claim 21, wherein
the detection conductive section is integrated with the monitor conductive section to constitute a single conductive plate section,
the conductive plate section is supported by a substrate section,
the monitor conductive section is a portion of the conductive plate section on a side closer to the substrate section in a plate thickness direction of the conductive plate section,
the detection conductive section is a portion of the conductive plate section on a side opposite to the monitor conductive section,
the monitor electrodes are provided to a principal surface of the conductive plate section, the principal surface being in contact with the substrate section, and
the deposition surface is provided to a principal surface of the conductive plate section, the principal surface being opposite to the principal surface.

23. The particulate matter detection apparatus according to claim 18, wherein
the control section heats the detection conductive section by using resistance heat generated by an electric current flowing through the detection conductive section, and
the control section is configured to control the temperature of the detection conductive section by controlling a voltage applied between the pair of detection electrodes.

24. The particulate matter detection apparatus according to claim 18, wherein
the particulate matter detection sensor includes a heater for burning the particulate matter deposited on the deposition surface and heats the detection conductive section by using heat generated by the heater, and
the control section is configured to control the temperature of the detection conductive section by controlling an amount of electric current flowing through the heater.
